(19) United States
(12) Patent Application Publication
(10) Pub. No.: US 2007/0092632 A1
(43) Pub. Date: Apr. 26, 2007

(54) Ultra high pressure modified proteins and uses thereof

(76) Inventors: Stan Kubow, Pointe Claire (CA); Larry Lands, Hampstead (CA); Laurie H.M. Chan, Prince George (CA); Charles Rohlicek, Montreal (CA); Ashraf A. Ismail, Montreal (CA); Hosahalli Ramaswamy, Bale D'Urfe (CA); Pedro Alvarez, Montreal (CA); Vijay Laxmi Grey, Hamilton (CA)

Correspondence Address: Jane Massey Licata;Licata & Tyrrell P.C., 66 E. Main Street, Marlton, NJ, 08053, US

(21) Appl. No.: 11/255,265

(22) Filed: Oct. 21, 2005

(51) Int. Cl. A23J 1/00

(52) U.S. Cl. 426/656

(57) ABSTRACT

The present invention is a method for increasing the digestibility of a food protein by subjecting the food protein to a single-cycle of ultra high pressure. Food proteins of the instant invention find application in nutraceutical, nutritional food, nutritional product or dietary supplement compositions for providing a protein source to a subject with a protein deficiency. In particular embodiments, the food protein is a whey protein useful in preventing or treating diseases or conditions associated with glutathione deficiency.

### BACKGROUND OF THE INVENTION

Ultra high pressure processing methods are growing as an alternative to the classical thermal food processing techniques. Applying ultra high hydrostatic pressures ranging from 100 to 1000 MPa has been shown to make foods safer and extends their shelf-life, while allowing the product to retain many of its organoleptic and nutritional attributes. This meets consumer demands for freshness without the disapproval related to other methods such as irradiation. Ultra high pressure has been used on many products to: inactivate food-borne pathogens (Ritz, et al. (2002) Int. J. Food Microbiol. 79:47-53), inactivate bacterial spores (Delacour, et al. (2002) Annales Pharmaceutiques Francaises 60:38-43), enhance (Jung, et al. (2000) J. Agric. Food Chem. 48:2467-2471) or inhibit selected enzymes (Garcia-Palazon, et al. (2004) Food Chem. 88:7-10), tenderize meat (Suzuki, et al. (1992) Colloque INSERM 224:219-27), shuck oysters (San Martin, et al. (2002) Crit. Rev. Food Sci. Nutr. 42:627-45), extend shelf-life (Lee, et al. (2003) Int. J. Food Sci. Technol. 38:519-524), promote ripening of cheeses (Saldo, et al. (2000) J. Food Sci. 65:636-640), and minimize oxidative browning (Hong, et al. (2001) J. Sci. Food Agric. 81:397-403). Ultra high pressure, in conjunction with elevated temperatures, can also be employed for the sterilization of many food products (Clery-Barraud, et al. (2004) Appl. Environ. Microbiol. 70:635-637; Spilimbergo, et al. (2002) J. Supercrit. Fluids 22:55-63).

Glutathione (GSH, γ-glutamyl-cysteinyl-glycine) is central to defense mechanisms against intra and extra-cellular oxidative stress (Wu, et al. (2004) J. Nutr. 134(3) :489-92). Since oxidative stress contributes to the development of muscular fatigue (Sen (1995) J. Appl. Physiol. 79(3) :675-86), increasing GSH stores can improve antioxidant defenses, improve muscular performance (Lands, et al. (1999) J. Appl. Physiol. 87(4) :1381-5) and aid in longevity (Miquel (2002) Ann. NY Acad. Sci. 959:508-16). Cysteine is generally the limiting amino acid for GSH synthesis in humans (Wu, et al. (2004) supra). Therefore, by supplementing one's diet with whey protein, which is rich in the oxidized form of cysteine, GSH levels can be augmented and muscular performance can be improved (Lands, et al. (1999) supra).

Whey protein isolate, subjected to three-cycles of ultra high pressure, increases tissue GSH levels significantly more than native whey protein isolate after 17 days of feeding the whey proteins at a dietary concentration of 24 weight % (Hosseini-nia (2000) Structural and nutritional properties of whey proteins as affected by hyperbaric pressure. Ph.D. thesis, McGill University). It has been suggested that triple-cycle pressurization treatment of whey protein, as opposed to single-cycle pressurization using 400 MPa, alters protein conformation to affect protein bioactivity thereby increasing the availability of disulfides to digestive enzymes and hence the bioavailability of sulphur amino acids for induction of tissue GSH (WO 01/50888). This may be due to the rapid proteolysis of the proteins in the small intestine, which leads to the liberation of small bioactive peptides which are more rapidly and preferentially absorbed in the small intestine (Scanff, et al. (1992) J. Dairy Res. 59(4) :437-47). It has been demonstrated that the biosynthesis of GSH in lymphocytes increases in response to intracellular elevations in cysteine (Gmunder, et al. (1990) Cell Immunol. 129:32-46).

Given the beneficial properties of increasing the bioavailability of food proteins, improved methods for increasing the digestibility of proteins are needed. The present invention meets this need.

### SUMMARY OF THE INVENTION

The present invention is a food protein composition composed of at least one protein subjected to a single-cycle of ultra high pressure. In particular embodiments, the protein is a protein fraction of milk or whey. In other embodiments, the food protein or protein fraction of milk or whey is in admixture with a suitable carrier or excipient to form a nutraceutical, nutritional food, nutritional product or dietary supplement composition.

The present invention is also a method for increasing the digestibility of a food protein by subjecting the food protein to a single cycle of ultra high pressure.

The present invention further embraces a method for increasing glutathione levels by administering an effective amount of a food protein composition of the invention to a subject so that glutathione levels are increased in the subject.

A method for preventing or treating a disease or condition associated with glutathione deficiency is also provided. This method involves administering an effective amount of a food protein composition of the invention to a subject thereby preventing or treating the disease or condition.

The present invention is also a method for providing a protein source to a subject with a protein deficiency by administering a composition of the invention.

### BRIEF DESCRIPTION OF THE DRAWINGS

FIG. 1 shows the non-reversible effect of pressure on the amide I′ region of the FSD-FTIR spectra of β-lactoglobulin (w=20.0, k=2.4). The pressure level was held for 30 minutes. Treatments are listed as the pressure level in MPa/holding time in minutes/number of cycles. The loss in general secondary structure is noticeable from 200 MPa of pressure.

FIG. 2 shows difference spectra from FIG. 1, β-lactoglobulin subjected to pressures from 0 to 400 MPa for 30 minutes.

FIG. 3 shows difference spectra of FSD-FTIR spectra of β-lactoglobulin subjected to instant pressures of 450, 550 and 650 MPa. Treatments are listed as the pressure level in MPa/holding time in minutes/number of cycles.

FIG. 4 shows ESI-MS absolute charge-state-distributions of the protein components in BIPRO® whey protein isolate after pressure. FIG. 4A, α-lactalbumin; FIG. 4B, β-lactoglobulin genetic variant A; FIG. 4C, β-lactoglobulin genetic variant B; and FIG. 4D, bovine serum albumin. Diamond, native protein; square, protein treated with one-cycle of 550 MPa pressure (550/0/1); and triangle, protein treated with three cycles of 400 MPa.

FIG. 5 shows ESI-MS absolute charge-state-distributions of the protein components in INPRO® whey protein isolate after pressure. FIG. 5A, α-lactalbumin; FIG. 5B, β-lactoglobulin genetic variant A; FIG. 5C, β-lactoglobulin genetic variant B; and FIG. 5D, bovine serum albumin. Diamond, native protein; square, protein treated with one-cycle of 550 MPa pressure (550/0/1); and triangle, protein treated with three cycles of 400 MPa.

FIG. 6 shows the effect of pressure treatment on digestion of whey proteins in vitro. Whey protein isolate was submitted to three-cycle treatment at 400 MPa and one-cycle pressure treatment at 550 MPa and lyophilized. A 3% solution (w/v) containing lyophilized material was prepared and digested with pepsin for 30 minutes in water a bath at 37° C. Aliquots were taken every 5 minutes and the protein content was determined at 590 nm (n=3). Error bars showed 95% CI of mean. Native whey protein isolate (3% solution) was used as a control. The numbers along the curves represent the percentage of proteins detected at 15, and 30 minutes. Time points within the same treatment not sharing common letters represent means that differed significantly (P<0.05) by Tukey's post hoc comparison for each treatment independently (Glm, multivariate). Treatments not sharing common capital letters represent means of multiple comparisons (Glm and repeated measures; within subject=time, between=treatment).

FIG. 7 shows the effect of pressure treatment on digestion of whey protein isolates in vitro. Whey proteins were submitted to two pressure (400 MPa) treatments (three-cycle and one-cycle) and a 3% solution of each whey protein was submitted to two independent experiments: pepsin digestion for 30 minutes or pepsin digestion followed by pancreatin digestion for an additional 60 minutes. In both experiments peptides with molecular weight lower than 1,000 Da were separated by ultrafiltration and the amount of peptides/amino-acid released at the end of the digestion with pepsin (on the left) and pancreatin (on the right) was determined at 340 nm (n=6). Error bars show 95% CI of mean. Native whey protein isolate (3% solution) was used as a control. Asterisks (*) indicate significant differences (P<0.05) between the treatments by ANOVA. Columns not sharing common letters represent means they differed significantly (P<0.05) by Tukey's post hoc comparison.

FIG. 8 shows mass spectrometric analysis of peptides released from digested native whey protein (FIG. 8A) and ultra high pressure-treated whey protein (FIG. 8B). The sequences of predominant peptides are indicated.

FIG. 9 shows mass spectrometric analysis of one HPLC peak obtained from separation of enzymatic digests of native (FIG. 9A) and ultra high pressure-treated (FIG. 9B) soy protein isolates. Arrows indicate peptides whose relative concentrations differ in digested native and ultra high pressure-treated soy protein isolates.

FIG. 10 shows food intake (FIG. 10A) and weight gain (FIG. 10B) in healthy animals (open symbols, FIG. 10A) and animals subjected to inflammatory challenge (closed symbols, FIG. 10A). Six animals were analyzed per group (ANOVA significant difference starting at week 4, p<0.03) and pressurized whey (circle) and chow (triangle) groups were collapsed into two groups of 12 in FIG. 10B (p<0.03).

FIG. 11 shows IL-8 secretion in normal (1HAEo⁻; FIG. 11A) and Cystic Fibrosis (CFTE29o⁻; FIGS. 11B-11F) cells grown in serum-free medium (FIGS. 11A-11C), 0.5% bovine serum albumin (FIGS. 11D and 11E), or 2% fetal bovine serum (FIG. 11F) in the presence or absence of 10 ng/mL TNF-α or the indicated amount of ultra high pressure-treated whey protein.

FIG. 12 shows a Box and Whisker plot for post-supplementation lymphocyte GSH levels. Group 1=15 grams/day; Group 2=30 grams/day; and Group 3=45 grams/day. The box represents the standard deviation, the black filled diamonds represents the mean value, and the bars represent the 95% confidence intervals. Y-axis is post-supplementation lymphocyte GSH levels in μmol/L.

### DETAILED DESCRIPTION OF THE INVENTION

The present invention is a novel method for modifying food proteins for nutraceutical, nutritional food or product, and dietary supplement use. The method employs the use of single-cycle, ultra high pressure processing of food proteins to improve protein characteristics such as digestibility. Improved digestibility of the instant food protein is achieved by at least partial denaturation of the food protein.

A food protein of the instant invention is a protein, isolated from its natural source, which is prepared for consumption by a mammal such as a companion animal, livestock animal, zoo animal or human. Natural sources of food proteins include milk (including buttermilk), egg, fungi or vegetables. In certain embodiments, the food protein is one or more milk proteins such a whey protein (e.g., β-lactoglobulin, α-lactalbumin, bovine serum albumin, lactoferrin, immunoglobulins, and glycomacropeptides). In other embodiments, the food protein is a protein fraction of milk or whey which contains a mixture of proteins. Suitable protein fractions include whey protein concentrate (35% to 90%), milk concentrate, milk protein concentrate, whey, reduced lactose whey, demineralized whey, or whey protein isolate. In other embodiments, the food protein is one or more vegetable proteins such as a soy protein (e.g., soy protein isolate). Desirably, the food protein being processed is by weight composed of 30%, 40%, 50%, 60%, 70%, 75%, 80%, 85%, 90%, 95%, 97%, or 98% protein.

Food proteins to be processed can be in liquid or solid form; however, in particular embodiments, the food protein is dry (e.g., lyophilized) to minimize water activities. Furthermore, the food protein can be at a pH of 3 to 12; however, embodiments of the instant invention embrace a food protein at, or near neutral pH (e.g., within one to two pH units, i.e., in the range of 5 to 9).

As used in the context of the instant invention, ultra high pressure processing, also referred to as ultra high hydrostatic or hyperbaric pressure processing or treatment, is the process by which a food protein in the form of a liquid or solid is subjected to pressures greater than 250 MPa (i.e., greater than 2500 Bar). In certain embodiments of the instant invention, pressures employed are in the range of 250 MPa to 1000 MPa. In particular embodiments, the food protein is subjected to at least 450 MPa, at least 500 MPa, at least 550 MPa, at least 600 MPa or at least 650 MPa of pressure.

Process temperatures for producing a food protein disclosed herein are generally in the range of −10° C. to 20° C., so that effects of adiabatic heat are minimized. Single-cycle exposure times at maximum pressure can range from a millisecond pulse (e.g., obtained by oscillating pumps) to a treatment of approximately 30 minutes. In certain embodiments, the exposure at maximum pressure is less than five minutes, four minutes, three minutes, two minutes or one minute. In particular embodiments, exposure to maximum pressure is less than ten seconds, five seconds, four seconds, three seconds, two seconds or one second. In still further embodiments, exposure at maximum pressure is one or milliseconds.

Ultra high pressure processing differs from homogenization in that decompression is achieved by expanding the compressed food protein against a constraining liquid causing it to do work and thus lowering its temperature towards its original value. Homogenization dissipates compression work as heat by expanding the product through an orifice or capillary.

Advantageously, ultra high pressure processing acts instantaneously and uniformly throughout a food protein mass, independent of size and shape. Thus, package size and shape are not factors in process determination. The work of compression during ultra high pressure treatment increases the temperature of food proteins through adiabatic heating. For the food proteins disclosed herein, adiabatic increases in temperature were in the range of 10° C. However, it is contemplated that food proteins containing a significant amount of fat can have higher adiabatic temperatures. Moreover, to achieve ultra high pressure-treatment, a variety of hydrostatic fluids can be employed in the pressure chamber including, e.g., water alone, or water containing a water-soluble oil.

Food proteins produced in accordance with the instant methods are an improvement over the art in that the instant food proteins have enhanced digestibility over native protein sources and are more economically viable to produce than food proteins subjected to multiple cycles of ultra high pressure. Accordingly, a single-cycle ultra high pressure-treated food protein of the instant invention is suitable for use in nutraceutical, nutritional food or nutritional product, and dietary supplement compositions.

A nutraceutical as used herein is a food that provides medical or health benefits, including the prevention and treatment of disease. Generally, a nutraceutical is a product produced from foods but sold in pills, powders, and other medicinal forms not generally associated with food. Such products may range from isolated proteins, dietary supplements and specific diets to processed foods such as cereals, soups and beverages. This definition also includes a bio-engineered designer vegetable food (e.g., rich in antioxidant ingredients), nutritional food or nutritional product, functional food, medicinal food or pharmafood.

For the purposes of the instant application, a dietary supplement is defined as a product that bears or contains one or more of the following dietary ingredients a vitamin, a mineral, an herb or other botanical, an amino acid, a dietary substance for use by man to supplement the diet by increasing the total daily intake of that substance, or a concentrate (e.g., a meal replacement or energy bar), metabolite, constituent, extract, or combinations of these ingredients.

A nutritional food or nutritional product is generally a food or product in the form of a health bar, health shake, yogurt or yogurt-based preparation, health drink, infant formula or a bakery product such as biscuit, cookie, muffin, bread, cereal, noodle, cracker, snack food or other similar forms of foods.

A food protein of the instant invention can be treated with ultra high pressure and directly ingested, or desirably provided in the form of a nutraceutical, nutritional food or nutritional product, or dietary supplement, wherein the food protein is in the form of a pill, capsule, tablet, liquid, bar, shake, cereal, sauce, yogurt, powder, suspensions, and the like. As such, the food protein is admixed with a suitable carrier or excipient to facilitate processing of the food protein into a particular shape or to improve palatability or solubility. A suitable carrier or excipient is a compound that is generally non-toxic and is commonly used to formulate compositions for animal or human consumption. The selection of suitable carrier or excipient can be readily determined by one of skill in the art and can be dependent upon the form of the food protein. Examples of suitable carriers and excipients include water, ethanol, glycerin, sodium citrate, calcium carbonate, calcium phosphate, starch (preferably potato or tapioca starch), alginic acid, certain complex silicates, sucrose, lactose, gelatin as well as high molecular weight polyethylene glycols, flavoring agents, coloring matter or dyes and, if so desired, emulsifying and/or suspending agents, and various combinations thereof. See, e.g., Remington: The Science and Practice of Pharmacy, Alfonso R. Gennaro, editor, 20th ed. Lippincott Williams & Wilkins: Philadelphia, Pa., 2000.

The sulfhydryl group of the cysteine in glutathione serves as a proton donor and is responsible for the preventing oxidative and tissue damage. Availability of cysteine is the rate-limiting factor in glutathione synthesis by cells since cysteine is relatively rare in foodstuffs. Whey proteins have been shown to supply the cysteine necessary for intracellular glutathione synthesis in vivo (Lands, et al. (1999) J. Appl. Physiol. 87:1381-1385). Having demonstrated that single-cycle ultra high pressure treated whey proteins have improved digestibility compared to native whey proteins and an enhanced ability to increase glutathione levels, nutraceutical, nutritional food or nutritional product, and dietary supplement compositions containing whey proteins of the instant invention are useful in methods of increasing glutathione levels and preventing or treating diseases or conditions associated with glutathione deficiency.

A method for increasing glutathione levels involves administering an effective amount of a composition containing a single-cycle ultra high pressure-treated whey protein to a subject so that glutathione levels are increased in the subject. As used in the context of the instant invention, an effective amount is one which provides at least a 2%, 5%, 10%, 15%, 20%, 25% or more increase in glutathione levels in a subject as compared to a subject who has not consumed a single-cycle ultra high pressure-treated whey protein. With regard to human adult consumption, such an effective amount is at least at least 15 grams/day, at least 20 grams/day, at least 30 grams/day, at least 40 grams/day, at least 45 grams/day or more. However, amounts consumed can vary depending on the subject (e.g., adult versus child or human versus non-human), as well as the intended use (e.g., to treat a disease or condition versus maintenance of glutathione levels).

As with native whey protein, single-cycle ultra high pressure whey proteins of the instant invention are useful in glutathione augmentation of states of glutathione deficiency. For example, glutathione augmentation with whey proteins has been shown to improve the nutritional status and immune response of patients with AIDS (Baruchel, et al. (1998) In: Oxidative Stress in Cancer, AIDS, and Neurodegenerative Diseases. Montagnier, et al. (Ed.) Marcel Dekker Inc., New York, pp. 447-461; Bounous, et al. (1993) Clin. Invest. Med. 16:204-209; Bounous, et al. (1998) Int. Diary Fed.: Whey, 293-305; Agin, et al. (2001) AIDS 15:2431-2440), increase longevity (Bounous, et al. (1989) Clin. Invest. Med. 12:343-349), enhance humoral immune responses (Bounous, et al. (1989) Clin. Invest. Med. 12:154-61; Bounous, et al. (1981) J. Infect. Dis. 144:281), decrease the occurrence of co-infections in rapidly progressive AIDS (Moreno, et al. (2005) J. Trop. Pediatr.), enhance muscular performance (Lands, et al. (1999) supra), improve pulmonary function and quality of life in obstructive airway diseases (Lothian, et al. (2000) Chest 117:914-916; Planas, et al. (2005) Clin. Nutr. 24(3) :433-41), reduce the deleterious effects of oxidative stress in the lung of Cystic Fibrosis (Grey, et al. (2003) J. Cyst. Fibros. 2:195-8), inhibit the development of chemically-induced cancer (Bounous, et al. (1988) Clin. Invest. Med. 11:213-217; Papenburg, et al. (1990) Tumor Biol. 11:129-136; Hakkak, et al. (2000) Cancer Epidemiol. Biomarkers Prev. 9:113-117), provide gastrointestinal support in subjects experiencing bowel restriction (Ksiazyk, et al. (2002) J. Pediatr. Gastroenterol. Nutr. 35:615-18; Rosaneli, et al. (2002) J. Med. Food 5:221-228; Matsumoto, et al. (2001) Biosci. Biotechn. Biochem. 65:1104-1111), improve liver dysfunctions in patients with chronic hepatitis B (Watanabe, et al. (2000) J. Med. 31(5-6):283-302) and promote wound healing by enhancing immune responses and providing protective measures in post-surgical patients (Zimecki, et al. (2001) Arch. Immunol. Ther. Exp. (Warsz) 49:325-333). Reducing oxidative stress via increases in glutathione levels is also useful in the treatment of Alzheimer's, Parkinsons, autism, chronic obstructive pulmonary disease, damage due to cigarette smoking, asthma, glucose regulation and insulin hypersensitivity, protection of end-organ damage in types I and II diabetes, and radiation poisoning. Moreover, as exemplified herein, single-cycle ultra high pressure-treated whey proteins are useful as antioxidants for reducing oxidative stress-induced damage resulting from ischemia/reperfusion, particularly cardiac reperfusion injury. Thus, whey protein compositions of the instant invention can be used prophylactically in patients who are scheduled to undergo a cardiac procedure, such as angiography or any procedure requiring pulmonary bypass, and are at risk for reperfusion injury. Patients having ischemic heart disease with transient obstruction of coronary vessels, or other diseases caused by reperfusion injury, e.g., cerebral vascular injury, could benefit from the whey protein compositions of the instant invention.

Accordingly, a single-cycle ultra high pressure-treated whey protein is useful for preventing or treating a disease or condition associated with glutathione deficiency. As used in the context of the instant invention, glutathione deficiency is intended to mean that the levels of glutathione are depleted or that there is not enough glutathione present to oppose the effects of the disease or condition. Subjects with glutathione deficiency or depleted levels of glutathione are administered an effective amount of a single-cycle ultra high pressure-treated whey food protein so that glutathione levels are increased and/or other signs or symptoms of the disease or condition are ameliorated, prevented or treated. The effectiveness of treatment can be routinely determined by the skilled clinician for the variety of diseases or conditions being treated based upon improvement or delay in the signs or symptoms associated with the particular disease or condition. In particular embodiments, the disease or condition being treated in cardiac reperfusion injury or Cystic Fibrosis.

In addition to increasing glutathione levels, whey proteins have been shown to exhibit bacteriostatic and bacteriocidal activity (Shah (2000) Br. J. Nutr. 84:S3-S10; Batish, et al. (1988) Aust. J. Dairy Tech. 5:16-18; Payne, et al. (1990) J. Food Prot. 53:4680472; Saito, et al. (1991) J. Dairy Sci. 74:3724-2730) and reduce rotavirus-induced disease symptoms (Wolber, et al. (2005) J. Nutr. 135:1470-1474). Moreover, whey protein peptides have been shown to reduce blood pressure by inhibiting angiotensin I converting enzyme (ACE) (Mullally, et al. (1996) Biol. Chem. Hoppe Seyler 377:359-60), thereby blocking the conversion of angiotensin I to angiotensin II, a highly potent vasoconstrictor molecule (Pihlanto-Leppala, et al. (2000) J. Diary Res. 67:53-64). Thus, it is contemplated, that whey protein compositions of the instant invention would be useful in the treatment of such diseases and conditions.

Similarly, soy protein isolates have been indicated for use in the treatment of cancer (See, et al. (2002) Immunol. Invest. 31:137-153; Hakkak, et al. (2000) supra) and therefore and the anticancer properties of soy protein may also be enhanced by treatment with single-cycle ultra high pressure.

Given the enhanced digestibility and bioavailability of a single-cycle ultra high pressure-treated protein, the present invention also embraces a method for providing a protein source to a subject with a protein deficiency. As used in the context of the present invention, a subject with a protein deficiency is intended to include a subject with depleted levels of protein, a subject in need of additional protein to achieve enhanced growth and development, or a subject exhibiting a disruption in protein metabolism due to a disease or condition (e.g., after surgery). As disclosed herein, body weight gain and feed efficiency ratios were increased in animals fed single-cycle ultra high pressure-treated whey protein relative to native whey protein. Thus, single-cycle ultra high pressure-treated whey is useful as a protein source for medical and animal feed applications involving protein deficiency to, e.g., enhance wound repair (MacKay & Miller (2003) Altern. Med. Rev. 8:359-377), provide gastrointestinal support in subjects experiencing bowel restriction (Ksiazyk, et al. (2002) supra; Rosaneli, et al. (2002) supra; Matsumoto, et al. (2001) supra), improve outcome in wasting conditions (Poullain, et al. (1989) J. Parenter. Enteral. Nutr. 13(4):382-6), enhance infant growth and development (Schmelzle, et al. (2003) J. Pediatr. Gastroenterol. Nutr. 36:343-351; Lucassen, et al. (2000) Pediatrics 106:1349-1354), increase the satiety response to control obesity (Hall, et al. (2003) Br. J. Nutr. 89:239-48), enhance muscle performance (Lands, et al. (1999) supra), and improve calf performance (Lammers, et al. (1998) J. Dairy Sci. 81:1940-5).

To illustrate the various embodiments of the instant invention, single-cycle high pressure (UHP) processing of β-lactoglobulin, α-lactalbumin, glycomacropeptides, and whey protein isolate was performed and characteristics of the resulting proteins were analyzed. These proteins were subjected to ultra high pressure treatment of 100, 200, 300 and 400 MPa for 30 minutes and changes in the secondary structure was determined by Fourier transform infrared spectroscopy (FTIR). The amide I′ absorption region (1700-1600 cm⁻¹) in the infrared spectrum of a protein is one of the most useful for secondary structure elucidation (Susi & Byler (1988) In: Methods for Protein Analysis. Cherry & Barford, Eds. American Oil Chemists Society. Champaign, Ill. pp. 235-250). The amide band assignments of whey proteins, as established in the art (Allain, et al. (1999) Int. J. Biol. Macromol. 26:337-344; Boye, et al. (1996) J. Dairy Res. 63:97-109; Dong, et al. (1998) Arch. Biochem. Biophys. 275-281; Hong & Creamer (2002) Int. Dairy J. 345-359; Hosseini-Nia, et al. (1999) J. Agric. Food Chem. 47:4537-4542; Lefevre & Subirade (2000) Biopolymers 54:578-586; Panick, et al. (1999) Biochemistry 38:6512-6519; Subirade, et al. (1998) Int. Dairy J. 8:135-140; Susi & Byler (1988) supra), are summarized in Table 1.

TABLE 1

| Band position | |
|---|---|
| (cm⁻¹) | Assignment |
| 1692 | Hidden antiparallel β-sheet |
| 1684 | Antiparallel β-sheet (aggregation) |
| 1680-1676 | β-Structure |
| 1645 | α-Helix and unordered |
| 1633 | Antiparallel β-sheet |
| 1629 | Parallel β-sheet |
| 1622 | Parallel β-sheet II |
| 1614 | Intermolecular β-sheet (aggregation band) |

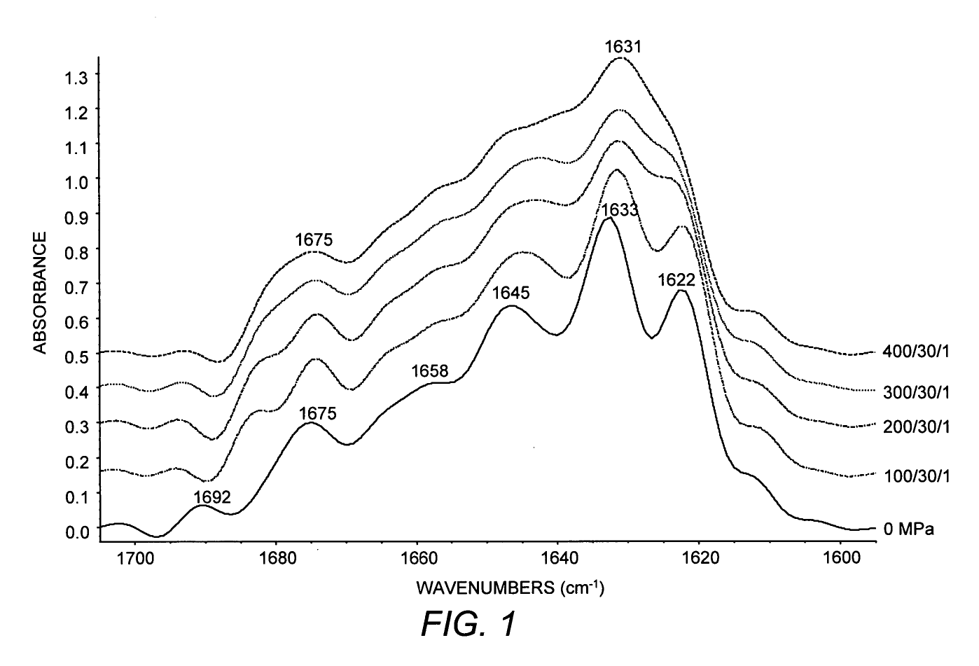

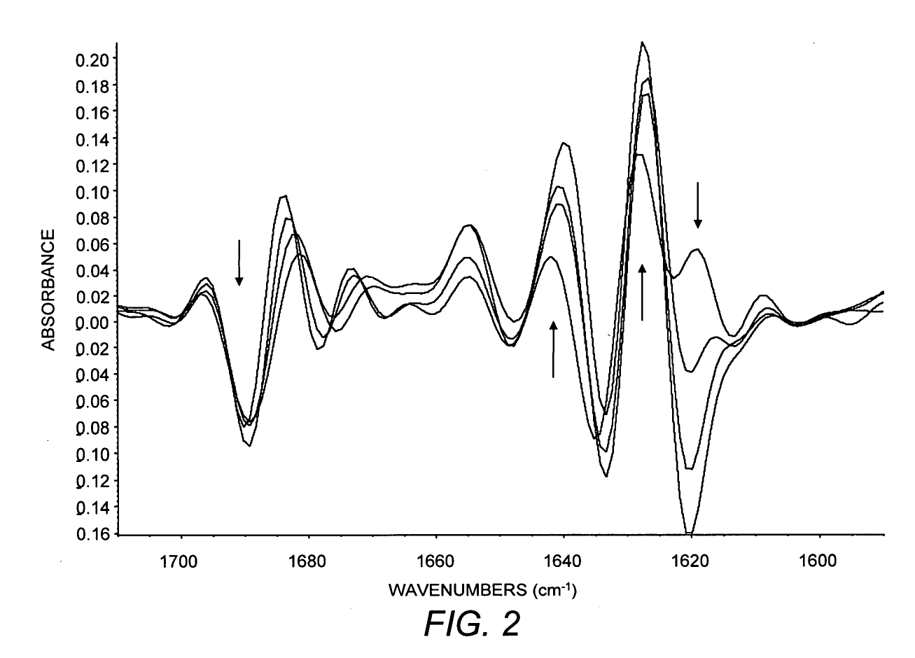

The irreversible changes in the secondary structure of β-lactoglobulin subjected to different pressure levels with a holding time of 30 minutes are shown in FIG. 1. The modification of secondary structure is evident from the changes in the relative intensity of the amide I′ band in the infrared spectra at 200 MPa. At 400 MPa the amide I′ bands become broader indicating appreciable loss of structural integrity. Also noticeable is the loss of the intensity of 1692 cm-⁻¹ band assigned to the H-bond amide groups of a β-sheet buried in the interior of the protein, inaccessible to the solvent (Boye, et al. (1996) supra). The loss in the band intensity of the 1692 cm⁻¹ peak was attributed to a change in tertiary structure causing the protein to become more flexible, or less tightly folded, which in turn allows the buried β-sheet to become accessible to D₂O. The exchange of hydrogen by deuterium (H/D exchange) of this β-sheet shifts the 1692 cm⁻¹ band to a lower wavenumber (Boye, et al. (1996) supra). A plot of the difference spectra shows the decline in the intensity of the 1692 cm-⁻¹ band as a function of pressure treatment (FIG. 2) and indicates that the change in the tertiary structure of β-lactoglobulin is observable above 100 MPa.

An increase in α-helix and unordered-structure content with increasing pressure was inferred from the increase in the intensity of the 1645 cm⁻¹ band. A significant reduction in the intensity of the band at 1622 cm⁻¹ is indicative of a reduction in parallel β-sheet structure with increasing pressure. This was accompanied by an increase in antiparallel β-sheet based on the increase in the intensity of the 1633 cm⁻¹ band. Accordingly, some of the parallel β-sheets may associate to form antiparallel β-sheet structures or form unordered/α-helical structures. These changes are associated with the formation of soft gels of the pressure treated β-lactoglobulin samples. Also disulphide bonds formation has been proposed as the mechanism that leads to the gelation of globular proteins (Fertsch, et al. (2003) Innov. Food Sci. Emerg. Technol. 4:143-150; Funtenberger, et al. (1997) J. Agric. Food Chem. 45: 912-921; Hong & Creamer (2002) supra; Kanno, et al. (1998) supra; Keim & Hinrichs (2004) supra; Panick, et al. (1999) supra).

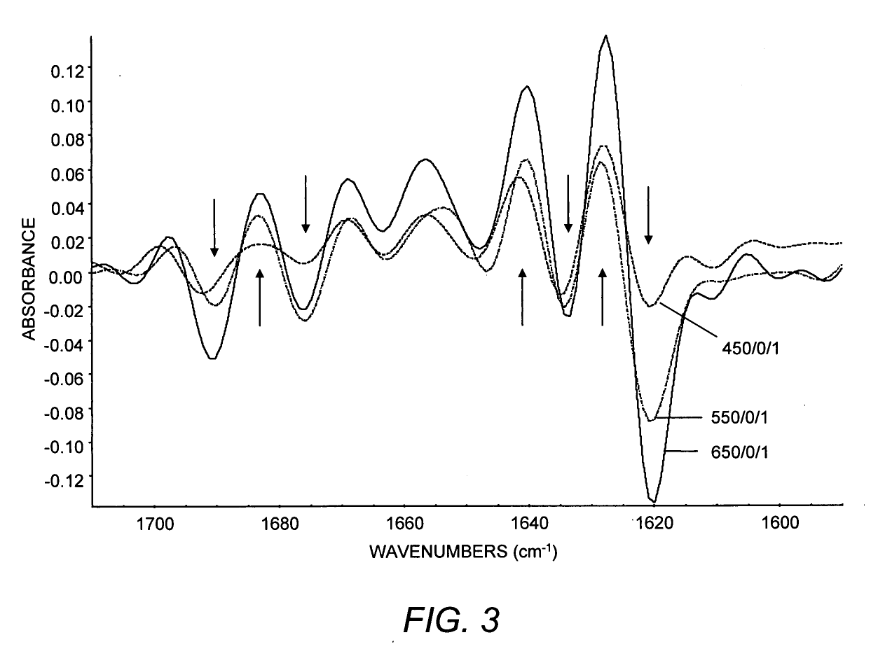

FTIR spectra of β-lactoglobulin samples exposed to UHP (450-650 MPa) without a holding time, were comparable to spectra recorded from pressure-treated samples at lower pressure with a 30-minute holding time. The specific structural changes of β-lactoglobulin using instantaneous ultra high pressure were derived from the difference spectra (FIG. 3).

In this case, the pressure-treated solutions of β-lactoglobulin in H₂O were freeze-dried and re-dissolved in D₂O, therefore the drop in absorbance of the peak at 1692 cm⁻¹ is indicative of some conformational change of the buried β-sheet. The band at 1645 cm⁻¹ assigned to α-helix or unordered structure increased with pressure, whereas the band at 1622 cm⁻¹ assigned to parallel β-sheet, and the bands at 1633 and 1676 cm⁻¹ assigned to antiparallel β-sheets, decreased with increasing pressure. The minor change in the intensity of the 1692 cm⁻¹ band indicates that the pressure-induced unfolding of the protein was partially reversible. The decrease in the 1622 cm⁻¹ band along with the 1633 cm⁻¹ band may indicate that the pressure induces an increase in unordered or α-helical structure (reflected in the increase in the 1645 cm⁻¹ band).

The pressurization of β-lactoglobulin and whey protein isolate samples lead to an increase in both viscosity and elasticity of the solutions (Table 2); the formation of a true gel where the elasticity (G′) is greater than the viscosity (G″) is only achieved when a holding time and higher number of pressure cycles are applied. For example, 3 pressure cycles at 650 MPa with a holding time of 5 minutes for each cycle produced strong β-lactoglobulin gels. This observation is in agreement with the findings from Fertsch et al. (2003) supra. To achieve the same gel strengths for WPI required higher holding times.

TABLE 2

| | |
|---|---|
| β-Lactoglobulin | Whey Protein Isolate |

| Treatment | G′ (Pa) | G″ (Pa) | G′ (Pa) | G″ (Pa) |
|---|---|---|---|---|
| Control | 2.14E−03 | 9.62E−03 | 2.59E−03 | 9.18E−03 |
| 450/0/1 | 3.81E−03 | 1.67E−02 | 4.89E−03 | 2.08E−02 |
| 550/0/1 | 6.20E−03 | 2.70E−02 | 5.08E−03 | 1.87E−02 |
| 650/0/1 | 4.56E−01 | 5.53E−01 | 1.28E−02 | 5.30E−02 |
| 450/0/3 | 3.86E−01 | 4.68E−01 | 3.71E−03 | 2.76E−02 |
| 650/5/3 | 3.22E+03 | 6.35E+02 | 2.57E+03 | 4.62E+02 |

Treatment is listed as the pressure level in MPa/holding time in minutes/number of cycles.

Samples of α-lactalbumin and glycomacropeptides were found to be insensitive to pressure regardless of the treatment; only a minor decrease in viscosity was observed when the glycomacropeptides sample was pressurized compared to the control, i.e., non-pressure-treated samples (Table 3). The relative insensitivity of α-lactalbumin to pressure treatment may be as a result of the re-folding of the protein when the pressure was released (Dzwolak, et al. (2000) Biopolymers 62:29-39). In the case of glycomacropeptides, these changes may also have been reversible due to the shorter peptide lengths of glycomacropeptides.

TABLE 3

| | |
|---|---|
| α-Lactalbumin | Glycomacropeptides |

| Treatment | G′ (Pa) | G″ (Pa) | G′ (Pa) | G″ (Pa) |
|---|---|---|---|---|
| Control | 2.10E−03 | 5.84E−03 | 3.99E−03 | 3.10E−02 |
| 450/0/1 | 1.53E−03 | 5.03E−03 | 2.21E−03 | 8.37E−03 |
| 550/0/1 | 2.58E−03 | 5.05E−03 | 2.17E−03 | 1.06E−02 |
| 650/0/1 | 2.57E−03 | 5.11E−03 | 2.57E−03 | 1.34E−02 |
| 450/0/3 | 1.56E−03 | 5.19E−03 | 2.70E−03 | 1.26E−02 |
| 650/5/3 | 1.93E−03 | 6.07E−03 | 3.85E−03 | 1.61E−02 |

Treatment is listed as the pressure level in MPa/holding time in minutes/number of cycles.

The β-lactoglobulin concentration selected for this analysis resulted in changes in the protein tertiary and secondary structure after relatively low pressure (100 to 400 MPa) with a 30-minute holding time and at higher pressures (450 to 650 MPa) without a holding time.

To further analyze the tertiary structure of a protein subjected to ultra high pressure treatment, β-lactoglobulin, α-lactalbumin, and whey protein isolates obtained from two different isolation methods were analyzed using electrospray ionization mass spectroscopy (ESI-MS). In the case of β-lactoglobulin, a mix of A and B genetic variants was used. Protein samples were treated at 450-650 MPa and translucent gels with very good water-holding capacity formed from pure β-lactoglobulin protein and BIPRO® whey protein isolate. In contrast, INPRO® whey protein isolate formed a turbid gel with poor water-holding capacity and α-lactalbumin solutions did not form gels.

The results of this analysis indicated that pure β-lactoglobulin solutions were largely insensitive to pressure treatment and the α-lactalbumin tertiary structure remained predominantly unchanged. β-Lactoglobulin A and B variants, the absolute charge-state-distribution of which were obtained by separating the data in two sets and taking into account only the relevant peaks corresponding to each genetic variant, behave similarly when exposed to the pressure treatments. Both native β-lactoglobulin showed a charge-state-distribution centered around +12 charges. After pressure was applied, the charge-state-distribution shifted to higher charges and was centred at +16 in all cases. Exposure to high hydrostatic pressure resulted in changes in the tertiary structure permitting some groups buried in the hydrophobic core of the molecule (Brownlow, et al. (1997) Structure. 5:481-495) and previously inaccessible to the solvent to get charged thereby increasing the charge-state-distribution. It was also noted that the changes in the tertiary structure also resulted in an increase in the viscoelastic properties of the β-lactoglobulin solution and ultimately led to gel formation. In the absence of any change in the tertiary structure, as in the case of α-lactalbumin, no change in the rheological properties was observed.

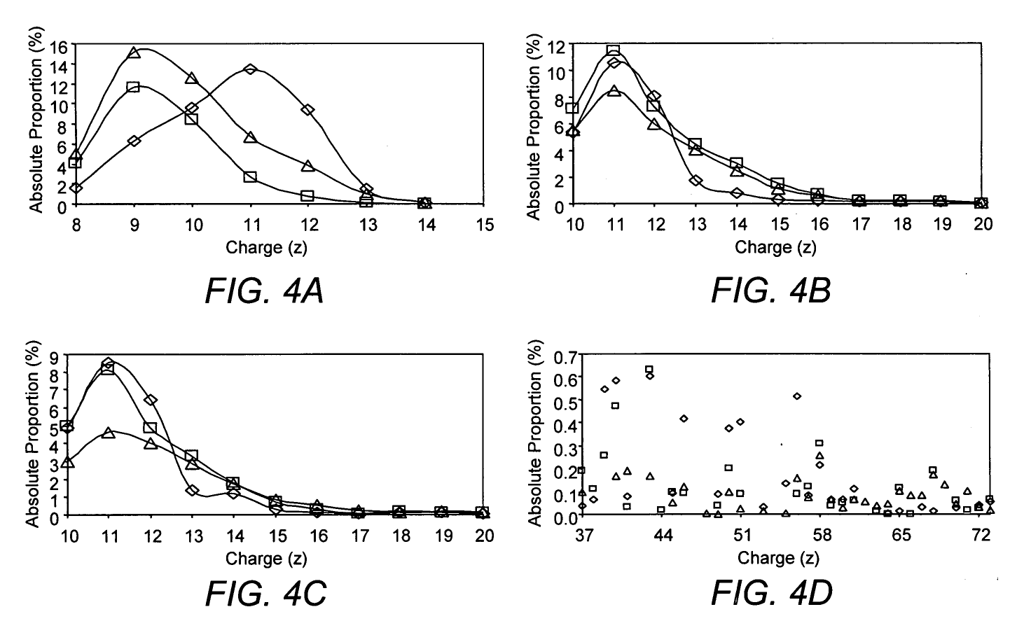

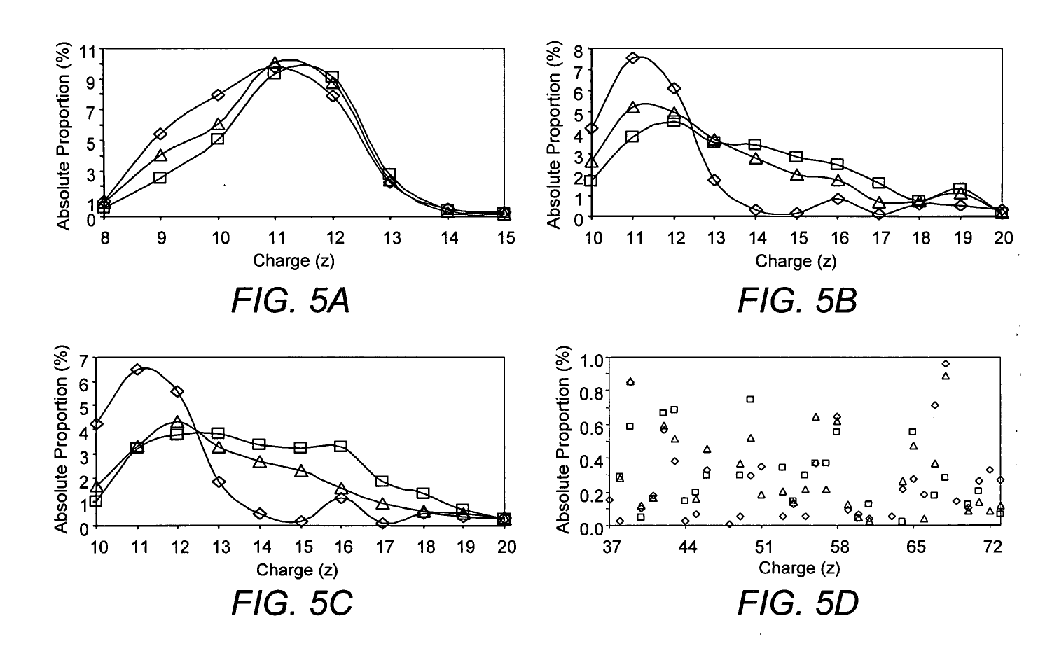

Absolute charge-state-distributions of each different protein component in the two sources of whey protein isolate were also calculated before and after pressure treatment (FIG. 4 and FIG. 5). Knowing the molecular mass of each of the protein components the data corresponding to β-lactoglobulin A, β-lactoglobulin B, α-lactalbumin and bovine serum albumin (BSA) could be separated from the relative charge-state-distribution of the whey protein isolate to create different absolute charge-state-distributions for each protein.

A dramatic +11 to +9 shift in charge was noted for α-lactalbumin in BIPRO® after pressure treatment (FIG. 4A), indicating that the α-lactalbumin fraction of BIPRO® was becoming even more compact after pressure treatment. Ultra high pressure treatment of the two β-lactoglobulin genetic variants in BIPRO® broadened the charge distribution to greater +11 (FIGS. 4B and 4C). There was no recognizable pattern assignable to the absolute charge-state-distribution of BSA (FIG. 4D), possibly attributable to the low concentration of this protein in the whey protein isolate.

Changes in the charge-state-distribution of α-lactalbumin from INPRO® whey protein isolate subjected to different pressure treatments are shown in FIG. 5A. There were minimal changes observed in charge after pressurization, indicating that α-lactalbumin remains intact. This is in contrast to α-lactalbumin in BIPRO®, which was sensitive to pressure treatment. The observed differences were believed to be due to the differences in pH of the two whey protein isolate solutions; BIPRO® had an unadjusted pH of 6.9, whereas INPRO® had an unadjusted pH of 5.9. Also differences in production methodologies can result in different relative protein components in whey protein isolate. BIPRO® whey protein isolate is produced using an ion exchange resin to concentrate the liquid whey and INPRO® is produced by cross-flow microfiltration. BIPRO® has a much lower content of glycomacropeptides than the amount found in INPRO®. Further, BIPRO® has 1200 ppm of calcium whereas INPRO® has 5293 ppm of calcium. Because α-lactalbumin binds calcium, the 4-fold increase in calcium content may result in structural stability of α-lactalbumin in INPRO® versus BIPRO® (Dzwolak, et al. (2000) Biopolymers 62:29-39).

Both pressure treatments applied to the INPRO® samples, i.e., 550 MPa without a holding time and three pressure cycles of 400 MPa, generated similar responses from the two β-lactoglobulin genetic variants (FIG. 5B and FIG. 5C). Before pressure treatment the charge for each genetic variant was centered at +11, and after pressure treatment the charge was broadened with a higher proportion of charges greater than +11. Thus, pressure caused partial unfolding of β-lactoglobulin, making more groups within the interior of the protein susceptible to salvation. Overall, the changes in the charge-state-distribution after pressure treatment observed in INPRO® were greater than those observed for β-lactoglobulin in BIPRO®. Thus, the native structure of β-lactoglobulin in INPRO® appears to be less stable resulting in gels with different Theological properties than those of BIPRO®.

The effects of different ultra high pressure treatments on the tertiary structure of whey proteins was further analyzed by near-ultraviolet circular dichroism (near-UV CD), fluorescence and Fourier transform Raman (FT-Raman) spectroscopy. The extrinsic probe 8-anilino-1-naphthalene sulfonic acid (ANS) is a small molecule that has a relatively weak fluorescence by itself, but when it binds to hydrophobic sites or pockets in a molecule, its fluorescence increases dramatically accompanied by a blue shift of ˜40 nm (Yang, et al. (2003) J. Food Sci. 68:444-452). This property is useful for the study of changes in tertiary structure of protein molecules which lead to exposure of hydrophobic sites previously unreachable by ANS (Ikeuchi, et al. (2001) J. Agric. Food Chem. 49:4052-4059; Laligant, et al. (1991) J. Agric. Food Chem. 39:2147-2155; Yang, et al. (2001) J. Agric. Food Chem. 49:3236-3243; Yang, et al. (2003) supra).

Powder β-lactoglobulin samples previously exposed to increasing ultra high pressure treatments were dissolved in water containing ANS. Increasing pressure treatments resulted in increasing fluorescence intensity. The fluorescence intensity at λₘₐₓ of 486 nm was plotted against the pressure (Table 4).

TABLE 4

| Pressure Treatment | Fluorescence Intensity |
|---|---|
| (MPa) | (Arbitrary Units) |
| 0 | 11.3 |
| 100 | 11.3 |
| 250 | 14.0 |
| 300 | 14.0 |
| 400 | 15.9 |
| 450 | 21.6 |
| 500 | 18.8 |
| 550 | 20.1 |
| 600 | 23.6 |

A positive relationship was clearly observed between pressure and fluorescence intensity. These results indicate that high pressure treatment opens the structure of β-lactoglobulin thereby allowing ANS molecules to reach the hydrophobic core of the protein. Alternatively, the protein is changing its three-dimensional structure so as to expose small hydrophobic pockets previously inaccessible to solvent or ANS.

The same set of samples used in the fluorescence experiments was analyzed by near-UV CD spectroscopy. The signals from Phe and Tyr residues did not follow any particular pattern, but the Trp intensity at 293 nm decreased with increasing pressure, with a maximum decrease observed with the 450 MPa pressure treatment. The latter may be attributed to a change in the spatial rearrangement of residues where the tryptophan amino acids are moving towards a more polar (or hydrophilic) environment (Aouzelleg, et al. (2004) J. Sci. Food Agri. 84:398-404; Ikeuchi, et al. (2001) supra; Yang, et al. (2001) supra).

The FT-Raman spectra of native, lyophilized β-lactoglobulin showed a band at 505 cm⁻¹, indicative of the presence of disulphide bonds (S-S). Infrared spectroscopy, which detects S-S, C-S and S-H modes and their varying conformations (Carey (1983) Trends Anal. Chem. 2:275-277; Li-Chan (1996) Trends Food Sci. Technol. 7:361-370), showed peaks at 830 and 850 cm⁻¹, attributable to tyrosine residues present in the protein. A band and shoulder at 1340 cm⁻¹ and 1360 cm⁻¹, respectively, were produced by the tryptophan residues. A sharp line at 1005 cm⁻¹ was caused by the vibration of the phenylalanine rings, also known as “ring breathing”. This vibration was insensitive to changes in conformation of the protein structure, and was useful as an internal intensity standard; samples were normalized against this band to correct for the smallest variation in concentration between samples (Li-Chan (1996) supra).

Table 5 summarizes some ratios of band intensities belonging to tryptophan and tyrosine residues that were useful for elucidating the tertiary structure of protein samples.

TABLE 5

| Side Chain | Band Ratio | Scenarios |
|---|---|---|
| Tyrosine | I₈₅₀/I₈₃₀ | Ratio around 1 |
| | | Tyr exposed to a polar environment |
| | | Ratio higher than 2.5 |
| | | Tyr acts as H-bond acceptor |
| | | Ratio lower than 0.5 |
| | | Tyr acts as H-bond donor |
| Tryptophan | I₁₃₆₀/I₁₃₄₀ | Ratio higher than 1 |
| | | Trp H-bonding in a hydrophobic |
| | | environment |
| | | Ratio lower than 1 |
| | | Trp H-bonding in a hydrophilic |
| | | environment |

Following these guidelines, the β-lactoglobulin spectra were analyzed. The position of tryptophans, tyrosines, and cystines in β-lactoglobulin exposed to different pressure treatments is listed in Table 6.

TABLE 6

| | Tryptophan | Tyrosine | Cystine |
|---|---|---|---|
| Treatment | Ratio I₁₃₆₀/I₁₃₄₀ | Ratio I₈₅₀/I₈₃₀ | I₅₀₅ |
| Control | 0.775 | 1.030 | 0.410 |
| 450 MPa | 0.740 | 1.000 | 0.390 |
| 550 MPa | 0.735 | 0.999 | 0.400 |
| 650 MPa | 0.730 | 1.030 | 0.380 |
| Three-Cycle | 0.740 | 1.001 | 0.412 |

Three-cycle treatment was 400/10/1 followed by 400/0/2.

The ratio of the intensity at 1360 cm⁻¹ over the intensity at 1340 cm⁻¹ was lower than 1.0 in all cases for tryptophan, therefore tryptophan was in a hydrophilic environment. The I₁₃₆₀/I₁₃₄₀ ratio also decreased with increasing pressure, indicating that the tertiary structure was affected by ultra high hydrostatic pressure treatment. These results are consistent with the ESI-MS data provided herein. Similar observations were found with thermally-induced gels (Nonaka, et al. (1993) J. Agric. Food Chem. 41:1176-81). The I₈₅₀/I₈₃₀ ratio of the tyrosine bands was ˜1 indicating that the tyrosine residues were exposed to a polar environment in all cases. This ratio also decreased with increasing pressure, which indicates that the tyrosine residues became buried in the molecule with increasing pressure exposure. In contrast to ANS fluorescence and near-UV CD spectroscopy analyses, no dramatic change in the FT-Raman spectrum was observed for samples exposed to 450 MPa pressure. This may have been due to the fact that the protein sample in this case was lyophilized, having a profound effect on the tertiary structure of the sample. Analysis of β-lactoglobulin cystine (S-S) residues was performed; however, the results were inconclusive as no discernable pattern was found due to weak signal.

As with β-lactoglobulin, the tertiary structure of BIPRO® and INPRO® whey protein isolates was analyzed. The fluorescence intensity of ANS bound to BIPRO® whey protein isolate increased with increasing pressure cycles, indicating that ANS was binding to additional hydrophobic regions exposed to ANS with increasing pressure treatment. Low pressure effects in the three-cycle treatment (i.e., 400 MPa) of BIPRO® whey protein isolate were compensated for by the 10-minute holding time in the first cycle and the additional two cycles. The single-cycle, 550 MPa pressure treatment of BIPRO® whey protein isolate (with no holding time) exhibited a slightly smaller increase in fluorescence compared to three-cycle treatment. In contrast, the fluorescence intensity of ANS bound to INPRO® whey protein isolate remained unchanged after either pressure treatment indicating that the proteins in INPRO® were less responsive to pressure treatment. The fluorescence intensity of the INPRO® samples were comparable to that of the non-pressure treated BIPRO® sample. As indicated herein, the higher calcium content of INPRO® may stabilize the proteins against pressure-induced conformational changes.

Overall, these data indicate that holding time and pressure levels can be modified to achieve comparable results, wherein lower pressures required higher holding times or multiple cycles. Holding time could be virtually eliminated when pressures exceeded 500 MPa. The three-cycle and single-cycle 500/0/1 treatments produced similar charge-state-distributions of whey protein isolate. High hydrostatic pressure induced changes in the tertiary structure of whey proteins indicative of a relaxation of the native structure of the molecule. Accordingly, single-cycle, ultra high pressure treatment (i.e., greater than 450 MPa) alters protein structure which could improve digestibility because gastro-intestinal enzymes can catabolize more of the protein (Korhonen, et al. (1998) Trends Food Sci. Technol. 9:307-319; Nakamura, et al. (1993) Milchwissenschaft 48:141-145; Smacchi & Gobbetti (2000) Food Microbiol. 17:129-141).

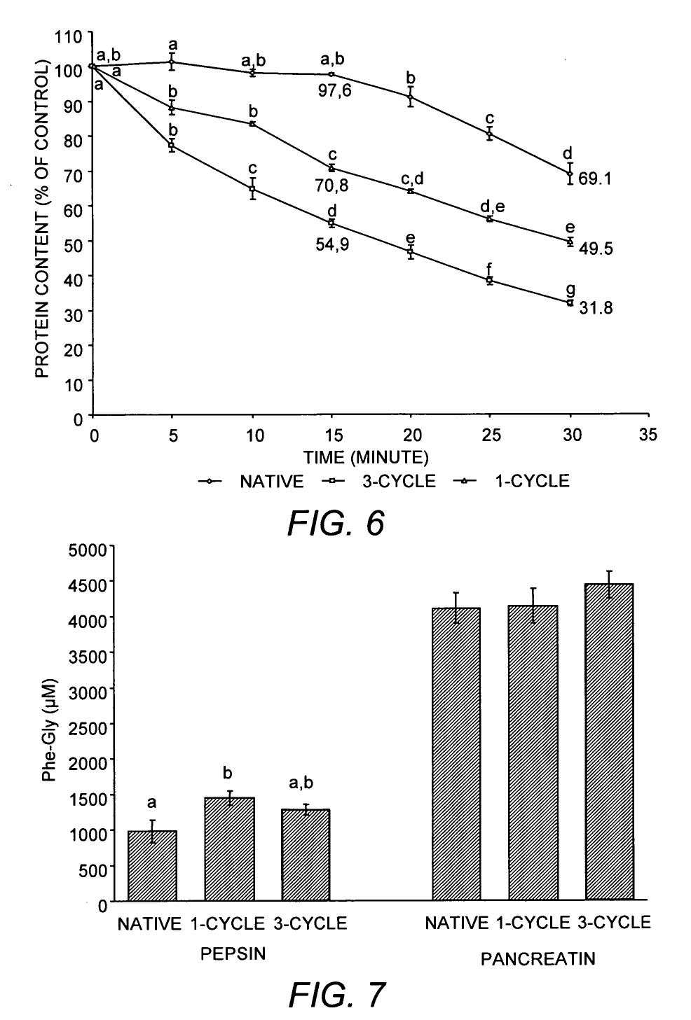

As whey is generally administered orally, the beneficial effects of whey are a result of the peptides generated through digestion, not the liberated amino acids. Thus, the digestibility of whey protein isolate subjected to ultra high pressure treatment was analysed by measuring digestion of one cycle and three cycle pressure-treated and native whey protein isolate in a closed digestion system; pepsin digestion (30 minutes) followed by pancreatin digestion (60 minutes). Native whey proteins were resistant to pepsin digestion with only 30.9% of the native protein being digested by pepsin to produce peptides smaller than 3 kDa (FIG. 6). Both one-cycle and three-cycle hyperbaric treatment considerably increased pepsin digestion as compared to native protein; 50.5% and 68.2% of peptides smaller than 3 kDa were produced after a 30 minute digestion, respectively (FIG. 6). These data indicate that protein conformational changes promoted by the hyperbaric treatment improved digestibility by allowing pepsin to reach peptide bonds not available in the native whey protein.

Given that peptides larger than 1 kDa are not observed in ileal juices of animal protein fed pigs (Qiao, et al. (2004) J. Animal Sci. 82(6) :1669-1678) it is expected that peptides greater than 1 kDa are absorbed into the brush border membrane. To mimic in vivo digestion and to compare the digestion efficiency of native and pressurized whey proteins, the presence of peptides less than 1 kDa was determined after pepsin and after pepsin plus pancreatin digestion of native and pressure-treated whey proteins. After 30 minutes of pepsin digestion, one-cycle pressure-treated whey proteins presented a significant (P<0.05) increase in the presence of peptides smaller than 1 kDa as compared to native whey protein hydrolysate (FIG. 7). Unexpectedly, whey proteins treated to three-cycles of pressure released an equivalent amount of peptides smaller than 1 kDa as was released by native whey protein digested with pepsin. However, pepsin and pancreatin digestion of whey treated to three-cycles of pressure did release significantly more peptides of less than 3 kDa than was observed with pepsin and pancreatin digestion of native protein. Thus, single-cycle ultra high pressure treatment of whey significantly improves the digestibility of whey protein and provides peptides which can be readily absorbed into the brush border membrane.

To analyze protein digestion in a more physiologically relevant manner, an open digestion system was developed, whereby peptides were removed from digestion as they are formed, and compared to whey protein digestion in the closed digestion system. Peptide release was assessed by o-phthaldialdehyde. In both digestion systems, pancreatin digestion was preceded by a 30-minute closed pepsin digestion. In the open system, peptide release started 30 minute after the beginning of pancreatin digestion (considered as baseline 100%) and continued throughout the 6 hour observed period (Table 7). In the closed system, peptide release reached near plateau after 60 minutes (Time 0 is the peptide value after 30 minutes pepsin digestion, considered as baseline 100% for the closed system). Thus, enhanced peptide release of ultra high pressure-treated weight was observed in the open digestion system as compared to the closed system, indicative of enhanced digestibility in vivo.

TABLE 7

% Peptide Appearance

| Time (Minutes) | Open Digestion | Closed Digestion |
|---|---|---|
| 0 | | 100 |
| 15 | | 186 |
| 30 | 100 | 218 |
| 45 | | 241 |
| 60 | 171 | 256 |
| 90 | 435 | |
| 120 | 672 | |
| 150 | 960 | |
| 180 | 1230 | |
| 210 | 1519 | |
| 240 | 1742 | |
| 270 | 2020 | |
| 300 | 2449 | |
| 330 | 2669 | |
| 360 | 2887 | |

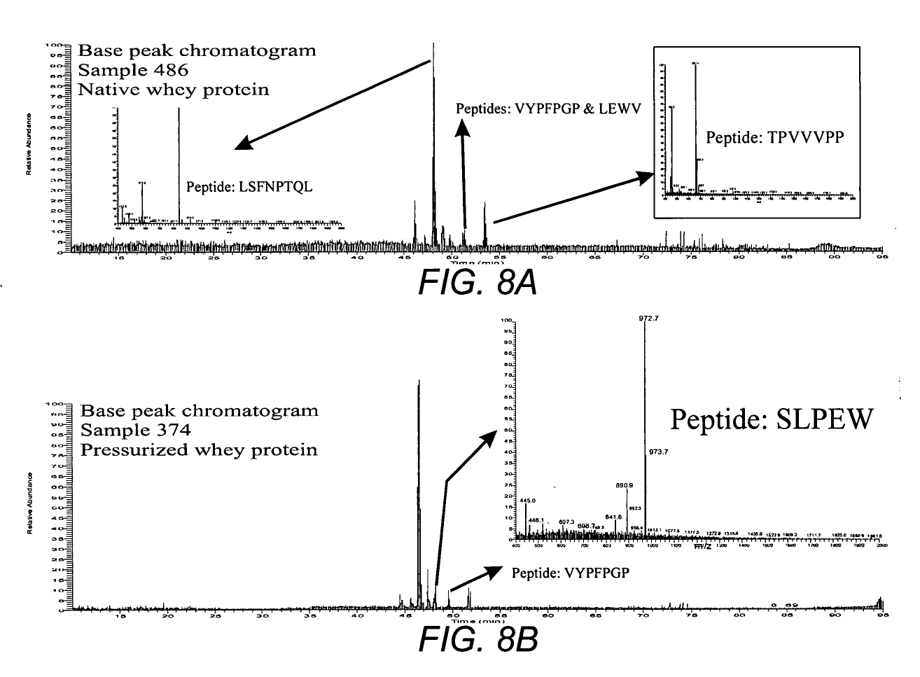

To analyze the peptide profile of digested single-cycle ultra high pressure-treated whey, liquid chromatography mass spectrometry (LC-MS) was employed. Digested pressure-treated whey was separated on a Thermo BIOBASIC® C18 column (Thermo Electron, Bellefonte, PA) (2% acetonitrile, 0.1% formic acid to 98% acetonitrile, 0.1% formic acid gradient in 90 minutes) and analysed by mass spectrometry (FINNIGAN LTQ™, mass range 400:2000 Da) with sequence analysis performed using DENOVOXT™ software (0.8 Da tolerance). Predominant peptides released during digestion of native whey included Leu-Ser-Phe-Asn-Pro-Thr-Gln-Leu (SEQ ID NO:1); Thr-Pro-Val-Val-Val-Pro-Pro (SEQ ID NO:2); Val-Tyr-Pro-Phe-Pro-Gly-Pro (SEQ ID NO:3); and Leu-Glu-Trp-Val (SEQ ID NO:4) (FIG. 8A). In contrast, digestion of ultra high pressure-treated whey exhibited a different peptide profile with Val-Tyr-Pro-Phe-Pro-Gly-Pro (SEQ ID NO:3) and Ser-Leu-Pro-Glu-Trp (SEQ ID NO:5) being predominant proteins (FIG. 8B). These data demonstrate that ultra high pressure-treated whey exhibits different digestion patterns than native whey; producing novel peptides.

Using diode array HPLC detection, a topographical examination was carried out at different intensities of UV absorbance of peptides generated from enzymatic hydrolysis of either native or pressurized soy protein isolates at multiple wavelengths ranging from 200 to 295 nm. There were differences in intensity between the presence of profiles of peptides present in native and the pressurized soy peptides. For example, there were a number of peptides from pressurized soy protein absorbing at 240-250 nm at the 6 minute elution time, whereas these same peptides were not observed in the hydrolyzed native soy protein.

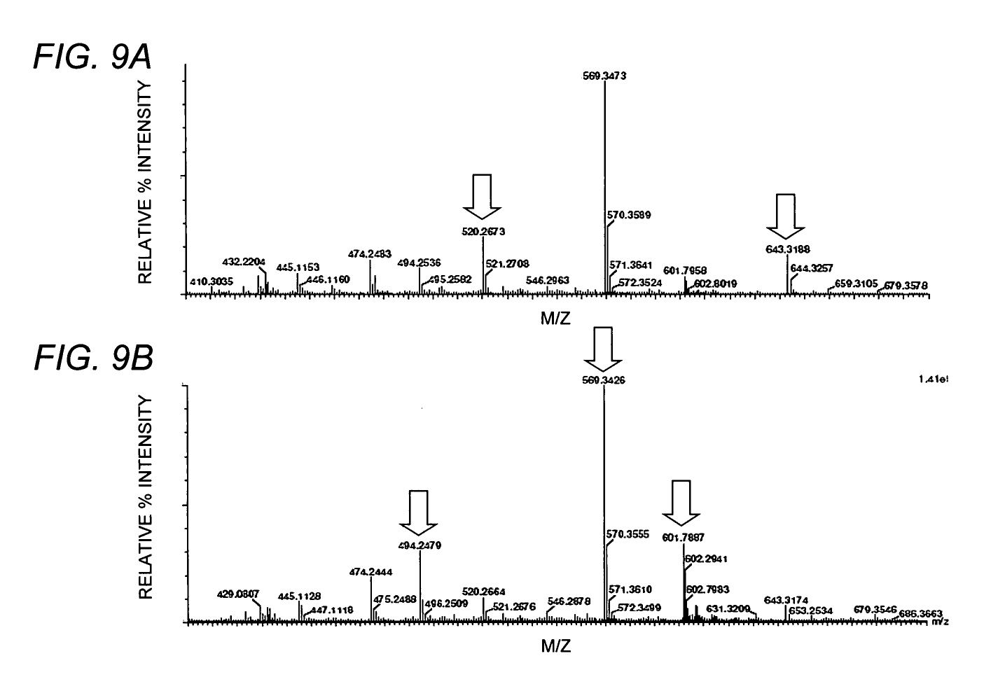

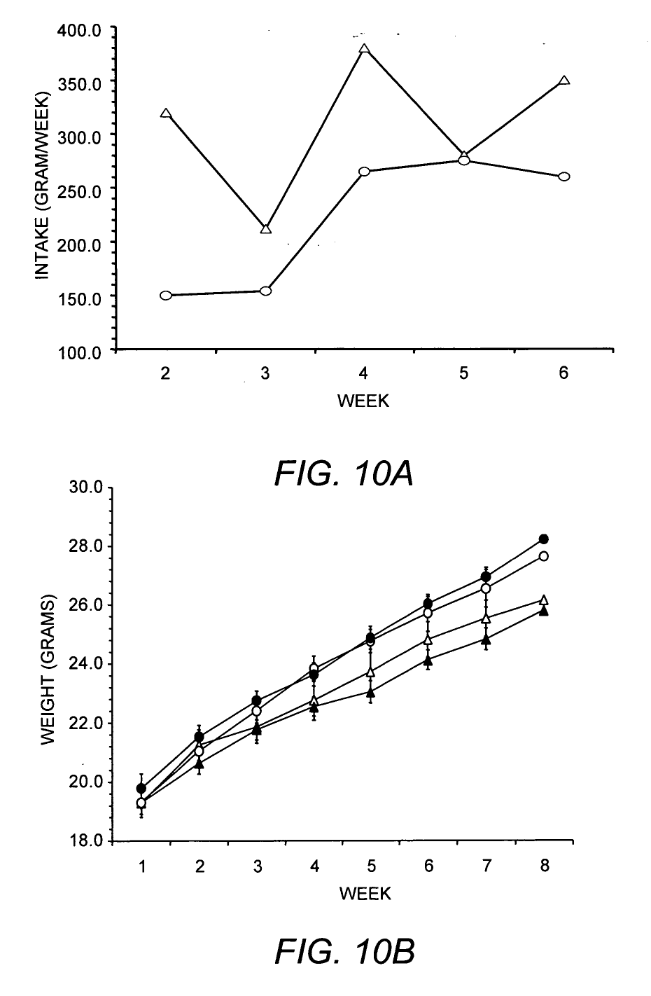

Since most peptides absorb at lower wavelengths of around 214 nm, soy peptides generated by hydrolysis of native or pressurized soy protein isolates were analyzed via HPLC at 214 nm to assess difference in % peak area. Although the native and pressurized soy peptides absorbing at 214 nm have similar profiles, there were differences in % peak area observed, particularly at 31 and 38 minutes. A small peptide peak at 31 minutes was selected for mass spectrometric analysis. Similar to digested ultra high pressure-treated whey protein isolate, digested ultra high pressure-treated soy protein isolate showed the presence of differing relative concentrations of peptides (FIG. 9B) as compared to native soy protein isolates (FIG. 9A). Upon inflammatory challenge, weight gain, feed intake, feed efficiency, and efficiency of protein utilization significantly decrease (van Heugten, et al. (1994) J. Anim. Sci. 72(10) :2661-9). However, increasing protein levels can improve weight gain and feed efficiency. Therefore, it was determined whether the improved digestibility of ultra high pressure-treated whey protein isolate could enhance weight gain in an animal subjected to an inflammatory challenge. Control (normal saline) and immunochallenged (ovalbumin) mice were fed chow or single-cycle ultra high pressure-treated whey protein isolate and consumption and weight gain where monitored weekly. Despite reduced uptake of pressure-treated whey (FIG. 10A), weight gain in control and immunochallenged mice fed pressure-treated whey protein isolate exceeded that of mice fed chow (FIG. 10B).

Moreover, the benefits of consuming single-cycle ultra high pressure-treated whey protein exceed those of native whey protein or whey protein subjected to three cycles of ultra high pressure. As shown in Table 8, animals fed for 38 days with a semi-purified diet containing 20 weight % of protein in the form of native whey protein isolate, whey protein isolated subjected to three repeated pulses of pressure, or whey protein isolate treated with a single cycle of ultra high pressure had similar initial body weights before being fed the experimental diets. The daily average intake of rats fed either single-cycle or three-cycle ultra high pressure-treated whey protein isolates was the same as that of rats fed the native whey protein isolate. However, the rats fed one-cycle ultra high pressure-treated whey gained significantly more weight (p<0.05) than did the rats fed native whey diet, whereas the body weight gain of the three-cycle pressure-treated whey group was not significantly different relative to the rats fed the native whey protein diet.

TABLE 8

| | Native^{1,2} | Three-Cycle^{1,2} | One-Cycle^{1,2} |
|---|---|---|---|
| Initial body weight, g | 113.6 ± 0.81 | 113.3 ± 0.95 | 114.9 ± 1.22 |
| Food intake, g/day | 20.0 ± 0.45 | 20.4 ± 0.49 | 20.0 ± 0.61 |
| Weight gain, g/day | 6.9 ± 0.13^{a} | 7.6 ± 0.14^{ab} | 7.7 ± 0.27^{b} |
| Final body weight, g | 381.6 ± 5.6^{a} | 406.6 ± ^{ab} | 411.9 ± 11.0^{b} |

¹Each value is presented as mean ± SE per group.
²Different superscript letters show significant differences as P < 0.05.

The feed efficiency ratio of the rats fed with the one-cycle ultra high pressure-treated whey diet was significantly higher than that of the rats fed the native whey diet (p<0.05), whereas no difference in feed efficiency was observed in rats fed the three-cycle pressure-treated whey versus the native whey protein diet (0.35±0.01 vs. 0.349±0.01). The rats fed the single-cycle ultra high pressure-treated whey protein diet also showed feed efficiency that trended higher (p<0.1) on comparison to that of the three-cycle pressure-treated whey protein diet group.

Accordingly, a diet composed of a food protein subjected to single-cycle ultra high pressure treatment results in significantly better body weight gain and greater feed efficiency ratios relative to native whey protein due to the improved digestibility of the protein. Thus, single-cycle ultra high pressure-treated whey is useful as a protein source for medical and animal feed applications involving growth and development, e.g., to enhance wound repair and improve outcome in wasting conditions.

Oxidative stress plays a significant role in chronic lung disease, diabetes, ischemic injury, Parkinson's disease, cancer, aging and Alzheimer's disease (Spector (2000) J. Ocul. Pharmacol. Ther. 16(2) :193-201). For example, cells of both the innate (e.g., neutrophils and respiratory epithelial cells) and adaptive (e.g., lymphocytes) immune systems are involved in lung inflammation of Cystic Fibrosis. Both epithelial cells and lymphocytes express Cystic Fibrosis transmembrane conductance regulator (CFTR) and in both cases, their immune responses are modulated by cell redox status, largely determined by the intracellular thiol concentrations, and in particular, GSH concentrations. In respiratory cells, pro-inflammatory stimuli incite production of Interleukin-8 (IL-8) and other mediators that recruit neutrophils to the airway lumen. The cytokine profile (Thl or Th2) expressed by T-helper lymphocyte cells is influenced by the GSH status of both antigen presenting cells and lymphocytes. The Th2 cytokine response is associated with a worse prognosis in Cystic Fibrosis, and increasing GSH levels, in antigen presenting cells and lymphocytes, can shift the cytokine profile away from Th2, and towards Thl. Undenatured whey protein supplementation has been shown to increase glutathione levels (Lands, et al. (2000) supra), decreasing exercise-induced bronchoconstriction (Baumann, et al. (2005) Med. Sci. Sports Exerc. 37(9) :1468-73). Accordingly, it was determined whether digested ultra high pressure-treated whey protein isolate could increase GSH levels in normal cells (human airway epithelial cell line, 1HAEo⁻) and Cystic Fibrosis cells (human tracheal epithelial cell line, CFTE29o⁻, which is homozygous for the F508 CFTR mutation) Normal 1HAEo⁻¹ and CFTE29o⁻ cells were cultured in monolayers and exposed to single-cycle, ultra high pressure-treated whey protein, which had been digested with trypsin, chymotrypsin, and peptidase. Digested pressure-treated whey protein had a significant effect on GSH levels of 1HAEo⁻¹ cells, with a less robust response evident in CFTE29o⁻ cells (Table 9). Aside from the digested enzymes employed, filtering of the digest whey protein with a 10 kDa cut-off also affected the response. Moreover, under the culture conditions used (24 hours in serum-free medium), N-acetylcysteine appeared to have an oxidative effect (see also, Chan, et al. (2001) Am. J. Respir. Cell Mol. Biol. 24(5) :627-32).

TABLE 9

| | % Baseline GSH | |
|---|---|---|
| Treatment | 1HAEo⁻ | CFTE29o⁻ |
| Basal medium | 100 | 100 |
| Unfiltered Pressurized whey (100 μg/mL) | 118 | 106 |
| Unfiltered Pressurized whey (500 μg/mL) | 109 | 96 |
| Filtered Pressurized whey (100 μg/mL) | 122 | 94 |
| Filtered Pressurized whey (500 μg/mL) | 113 | 95 |
| N-acetylcysteine (10 mM) | 84 | 74 |

Analysis of GSH levels in CFTE29o⁻ cells was extended by culturing the cells for 48 hours (minimal essential medium with 2% fetal bovine serum) with 12.5 ug/mL native whey or ultra high pressure-treated whey digested for 30-minutes with pepsin digestion followed by a 60-minute pancreatin digestion. GSH levels, as a percent of baseline, were significantly higher in CFTE29o⁻ cells grown in the presence of digested ultra high pressure-treated whey (134% of baseline GSH) than in cells grown in the presence of digested, native whey (93.7% of baseline GSH, p<0.05).

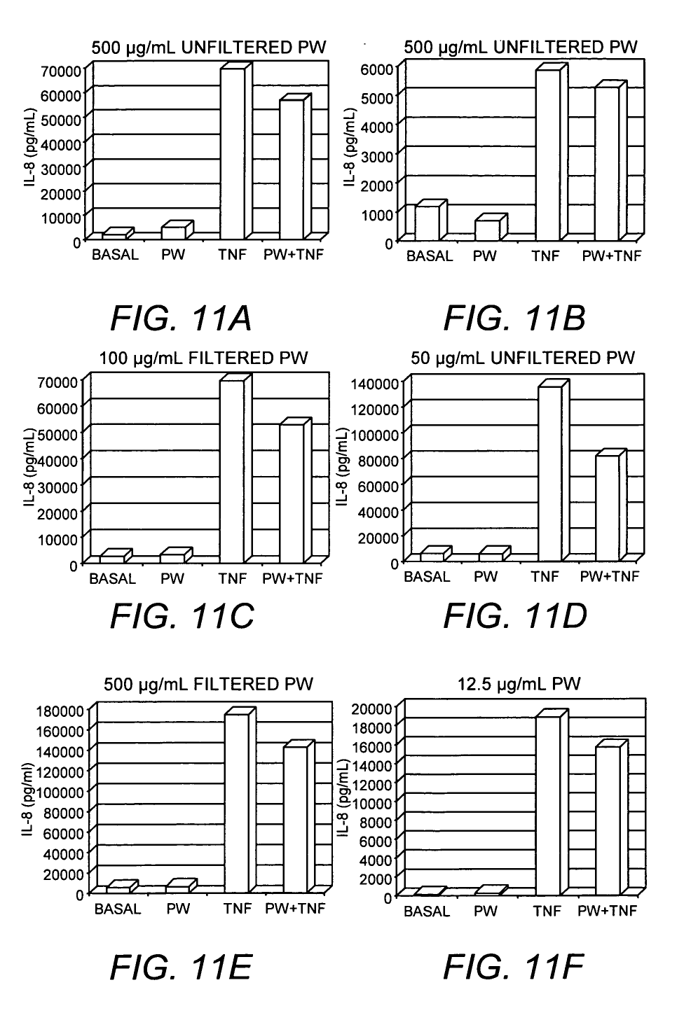

To further characterize the response of CFTE29o⁻ cells to ultra high pressure-treated whey, normal 1HAEo⁻ and CFTE29o⁻ cells were exposed to single-cycle, ultra high pressure-treated whey protein under a variety of growth conditions to evaluate IL-8 secretion upon TNF-α stimulation (10 ng/mL, 1 hour). The data presented in FIG. 11 indicate that ultra high pressure-treated whey (PW), under different conditions, can significantly reduce IL-8 production in normal and Cystic Fibrosis cells. Moreover, the decrease in IL-8 production is associated with nuclear translocation of NF-KB from the cytosol. Because IL-8 is the primary chemoattractant for neutrophils, these data indicate that ultra high pressure-treated whey provides beneficial immunomodulatory effects. The effectiveness of using undigested pressurized whey protein isolate to augment glutathione (GSH) levels in vivo was also determined. Total lymphocyte GSH levels were measured in subjects randomized to three different doses of pressurized whey protein supplements. The characteristics of the subjects enrolled in the study are listed in Table 10. There was no difference in any of the subject characteristics between the three groups. Furthermore, there was no significant change in any of the anthropometric characteristics. There was no significant difference between the groups as to the total number of hours of reported physical activity per day before (8.7±3.0 hours per day) or 2 weeks post-supplementation (8.4±3.1 hours per day), nor was there a significant change over time for any group. Five out of thirty-one subjects (16%) reported having gastrointestinal discomfort during the period of supplementation (1 individual in the 15 grams/day group; 3 in the 30 grams/day group; and 1 in the 45 grams/day group).

TABLE 10

| | Group 1 | Group 2 | Group 3 |
|---|---|---|---|
| | (15 g/day) | (30 g/day) | (45 g/day) |
| | n = 11 | n = 12 | n = 8 |
| | 5 females | 6 females | 4 females |
| | 6 males | 6 males | 4 males |
| Age (years) | 23.8 ± 2.9 | 26.3 ± 5.9 | 21.6 ± 2.3 |
| Weight (kg) | 75.3 ± 12.1 | 72.5 ± 13.9 | 74.6 ± 14.8 |
| Height (cm) | 174.9 ± 10.7 | 173.4 ± 8.1 | 173.0 ± 11.3 |
| BMI (kg/m²) | 24.6 ± 3.3 | 24.0 ± 3.3 | 24.7 ± 2.2 |
| Pre GSH levels* | 3.9 ± 0.9 | 3.4 ± 0.4 | 3.7 ± 0.4 |

*Pre GSH levels are expressed as μmol/L or μmol per 2 million cells.
Body mass index (BMI) is calculated as weight (kg) divided by height (meters).
No variable was different between groups (P > 0.05). Also, no variable was significantly different post-supplementation compared to pre supplementation (P > 0.05).

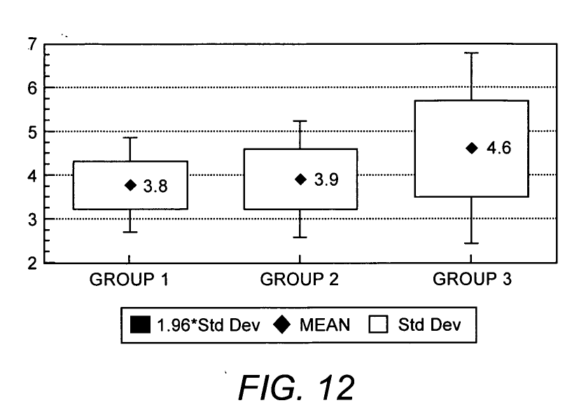

Pre-supplementation lymphocyte GSH levels were not significantly different between groups (weighted mean=3.7±0.7 μmol/L or μmol per 2 million lymphocytes). The variables, age, height, weight, body mass index, and total pre-supplementation lymphocyte GSH levels were examined by forward stepwise multiple regression to predict post-supplementation total lymphocyte GSH levels. The variables that appreciably affected post-GSH levels were group, height, and gender. The regression formula was post-supplementation lymphocyte GSH levels in μmol/L=[0.426 (group)]+[0.683 (gender)]+[0.045 (height)]−5.61 (Adjusted r²=0.23; SEE=0.72 μmol/L; P<0.05) where post-supplementation lymphocyte GSH levels are expressed in μmol/L; group is expressed as 1, 2, or 3 (group 1=15 gram/day, group 2=30 gram/day, and group 3=45 gram/day of pressurized whey protein isolate, respectively); gender is expressed as 1 or 2, (1=male, 2=female); and height in cm. Since females were generally shorter than males (168.4±6.3 versus 179.7±9.2 cm), it is understandable that gender and height played a significant role in the multiple regression analysis. Adding the other variables age, weight, and pre-supplementation lymphocyte GSH levels to the equation did not increase the coefficient of determination significantly and tended to increase the standard error of the estimate (SEE). Therefore, post-supplementation lymphocyte GSH levels were best predicted by group, gender and height. The group which ingested 45 grams of pressurized whey per day augmented lymphocyte GSH levels the most (i.e., by ˜24%; FIG. 12). However, while there was a significant relationship between dosage of supplementation and lymphocyte GSH levels post-supplementation, it was not in a dose-dependent manner (FIG. 12).

Pressurized whey protein isolate supplementation of 45 g/day for 2 weeks (630 grams total) showed similar increases to that using native whey protein supplementation of 20 g/day for three months (Lands, et al. (1999) supra) Since the day-to-day variability of lymphocyte GSH levels is less than 3% (˜0.10 μmol/L) over a three-month period (Lands, et al. (1999) supra), pressurized whey protein isolate of 45 grams per day can consistently augment lymphocyte GSH levels at a rate that is six times faster than native whey protein supplementation using three times less protein. Therefore, treatment of whey protein by pressurization increases the availability of disulfides to digestive enzymes and the bioavailability of sulphur amino acids for induction of tissue GSH. The increased GSH levels disclosed herein are biologically significant because similar increases in human lymphocyte GSH concentrations induced by L-oxothiazolidine 4-carboxylate reduced in vitro sulfur mustard cytotoxicity (Gross, et al. (1997) Cell. Biol. Toxicol. 13:167-73) and increased the lymphocyte response to mitogen stimulation (Fidelus & Tsan (1986) Cell. Immunol. 97:155-63).

Reactive oxygen/nitrogen species in resident airway cells are important in bronchoconstriction. Glutathione is a major lung antioxidant and undenatured whey protein supplementation has been shown to increase glutathione levels (Lothian, et al. (2000) Chest 117(3) :914-6) and improve postchallenge pulmonary function (Baumann, et al. (2005) Med. Sci. Sports Exerc. 37(9) :1468-73). Accordingly, supplementation with ultra high pressure-treated whey protein isolate was evaluated in a mouse ovalbumin sensitization model (Hammelmann, et al. (1997) Am. J. Respir. Crit. Care. Med. 156(3 Pt 1) :766-75). Responses to inhaled methacholine (10 μg/mL) in mice after sensitization and airway challenge with ovalbumin were measured. Ovalbumin-sensitized and -challenged animals had increased airway responsiveness to aerosolized methacholine compared with control animals (i.e., sensitized and challenged with normal saline). However, animals supplemented with ultra high pressure-treated whey protein isolate exhibited reduced airway responsiveness compared to animals supplemented with chow (Table 11).

TABLE 11

| Supplement | Resistance | BAL IL-13 |
|---|---|---|
| (Sensitization/Challenge) | (cm H₂O•s/mL) | (pg/mL) |
| Chow (NS/NS) | 0.89 | 83.4 |
| Chow (Ova/Ova) | 1.62 | 138.8 |
| Whey (NS/NS) | 1.25 | 64.4 |
| Whey (Ova/Ova) | 1.39 | 57.6 |

NS, normal saline;
Ova, ovalbumin.
Median values are presented (resistance, n = 3-4; IL-13, n = 2-3).

The immunomodulatory properties of single-cycle ultra high pressure-treated whey protein isolate were further analyzed by measuring IL-13 production in bronchoalveolar lavage of ovalbumin-sensitized and -challenged animals. The results of this analysis indicated that supplementation with ultra high pressure-treated whey was highly effective at reducing the production of the Th2 cytokine IL-13 in this sensitization model (Table 11). These data are highly relevant to the treatment of Cystic Fibrosis, because IL-13 is elevated in Cystic Fibrosis patients chronically colonized with Pseudomonas aeruginosa.

Oxidative stress also plays a significant role in injury to the heart as a result of myocardial ischemia and reperfusion. Therefore, it was determined whether recovery of myocardial contractile function following ischemia-reperfusion injury could be enhanced by supplementing with single-cycle, ultra high pressure whey. These experiments were conducted on isolated hearts of 20 adult Sprague-Dawley rats. Ten rats were fed for 4 weeks with semi-elemental diets containing native whey protein diet and ten were fed with a similar diet containing whey treated with ultra high pressure. The hearts were perfused in the Langendorff mode and underwent an initial 20-minute stabilization period, followed by 20 minutes of global zero-flow ischemia and 35 minutes of post-ischemic reperfusion.

The hearts of rats fed the pressure-treated whey diet had less marked hyper-contracture in the immediate period (30 seconds to 3 minutes) following reperfusion with peak left ventricular pressures of 153±15 mmHg for rats fed pressure-treated whey versus 185±8 mmHg (SEM) for rats fed native whey protein (P<0.05). The period of reperfusion arrhythmia (atrial tachycardia, AV node block, or ventricular ectopy) was also much shorter in the hearts of the animals fed the pressure-treated whey diet (86±18 seconds versus 287±8 seconds, P<0.001). Scoring of the reperfusion ventricular ectopy in accord with the Lamberth Convention (Walker (1988) Cardiovasc Res. 22:447) and Lown grading system also indicated significantly less reperfusion ventricular arrhythmias over a period of 30 minutes (5.0±1.1 versus 25±0.2, P<0.001) in animals fed the pressure-treated whey diet. Because hypercontracture is an index of the ischemic stress, which by itself mechanically damages the heart, and post-ischemia arrhythmias are a major source of morbidity and mortality, a diet supplemented with single-cycle, high pressure-treated whey protein could reduce signs of myocardial ischemia-reperfusion injury.

The invention is described in greater detail by the following non-limiting examples.

### EXAMPLE 1

Materials

Proteins analyzed herein included 90% dry basis beta-lactoglobulin protein powder; 95% dry basis alpha-lactalbumin protein powder; 90% dry basis glycomacropeptides (GMP) powder; 90% dry basis whey protein isolate BIPRO® (Davisco Foods International, Eden Prairie, Minn.), and 90% dry basis whey protein isolate INPRO® (Inovatech, Abbotsford, BC, Canada) each used without further purification. Deuterium oxide (D₂O 99.9% D) was purchased from Aldrich (St. Louis, Mo.).

### EXAMPLE 2

Ultra High Pressure Treatment

Ultra high pressure treatment was achieved using an Alstom Co. (Nantes, France) ultra high pressure machine unit, with a chamber volume of 3 Litres. The pressure medium used was water. The maximum operational pressure of 650 MPa was reached in approximately 4 minutes and the depressurization time was approximately 10 seconds. The sample was placed in the high pressure vessel at 4° C. and during pressurization the adiabatic increase in temperature reached a maximum 10° C.

The following notation was employed to designate the physicochemical parameters used: P/t/C where P is the pressure level in mega-Pascals (MPa); t is the holding time in minutes; and C is the number of cycles, i.e., how many times the pressure level and holding time was achieved, released and applied again. For example, 650/5/3 means a pressure treatment at 650 MPa, with 5 minutes of holding time, repeated 3 times.

A three-cycle treatment was also used in some cases. This treatment involved bringing the pressure up to 400 MPa and holding it for 10 minutes, then releasing the pressure and subjecting the sample to two addition pressure cycles of 400 or 650 MPa pressure without a holding time (i.e., 400/10/1 followed by 400/0/2) (Funtenberger, et al. (1997) supra; Garcia-Palazon, et al. (2004) supra).

### EXAMPLE 3

FTIR Analysis

Series A. Solutions of 12.5% (w/v) β-lactoglobulin protein in D₂O were prepared and sealed in plastic bags for high pressure treatment. This concentration was selected to avoid the formation of pressure-induced hard gels which are difficult to analyze by FTIR spectroscopy. Sample bags were submerged in the water chamber and subjected to 100, 200, 300 and 400 MPa treatment with 30 minutes of holding time. After pressure treatment, the FTIR spectrum of each sample was recorded.

Series B. Solutions of 12.5% (w/v) protein (β-lactoglobulin, α-lactalbumin, glycomacropeptides, and BIPRO® whey protein isolate) in D₂O were prepared and sealed in plastic bags for high pressure treatment. Sample bags were submerged in the water chamber and subjected to UHP treatment 450/0/1; 550/0/1; 650/0/1 and 650/5/3. After pressure treatment, each sample was divided in two; one part used to record the rheological properties of the samples and the other part was immediately frozen, lyophilized and re-dissolved in D₂O to a concentration of 5% (w/v) for FTIR spectroscopic analysis.

Series C. Samples of 12.5% (w/v) protein (β-lactoglobulin, α-lactalbumin, glycomacropeptides, and BIPRO® whey protein isolate) were pressurized as follows: 450/0/1, 550/0/1, 650/0/1, 450/0/3 and 650/5/3; and analyzed right after pressure treatment without further manipulation. All measurements were recorded using an AR-2000 rheometer (TA Instruments, New Castle, Del.) employing a parallel plate geometry, constant angular frequency of 1 Hz (0.6284 rad/sec) and controlled temperature of 10° C. G′ and G″ parameters were recorded at 100 seconds operational time, which was considered to be the equilibration time.

FTIR Spectroscopy. FTIR spectra were recorded using a Nicolet 8210E FTIR spectrometer (Thermo Nicolet Corp., Madison, Wis.) equipped with a deuterated triglycine sulphate (DTGS) detector. The spectrometer was continuously purged with dry air from a Balston dryer (Balston, Lexington, Mass.).

Approximately 8 μL of a 5% (w/v) protein sample in D₂O were placed between two CaF₂ windows separated by a 50 μm thick TEFLON® spacer. The temperature of the cell was regulated by an Omega temperature controller (Omega Engineering. Stamford, CT). A total of 512 scans were co-added at 4 cm⁻¹ resolution. The absorbance spectra were subjected to band narrowing techniques using Fourier self deconvolution (FSD) employing a bandwidth of 20 cm⁻¹ (w) and enhancement factor of 2.4 (k) followed by a two-point baseline correction starting at 1710 and ending at 1590 cm⁻¹ using Omnic 6.0 software (Thermo Nicolet Corp., Madison, Wis.).

### EXAMPLE 4

MSI-MS Analysis

Experiment A. Solutions of 15% (w/v) of each of the major components found in whey, namely β-lactoglobulin and α-lactalbumin, were prepared in H₂O, and sealed in plastic bags for high pressure treatment. This concentration was selected to avoid the formation of hard β-lactoglobulin gels which after lyophilization can be difficult to re-dissolve. Samples bags were submerged in the water chamber and the ultra-high pressure treatments applied were 450/0/1, 550/0/1, 650/0/1 and a three-cycle treatment at 400 MPa (i.e., 400/10/1 followed by 400/0/2). After pressure treatment, the samples were immediately frozen, subsequently lyophilized and re-dissolved to 0.5 mg/mL in 1% aqueous acetic acid (pH 3) for ESI-MS examination.

Experiment B. Solutions of 15% (w/v) BIPRO® and INPRO® whey protein isolates in H₂O were prepared, and sealed in plastic bags for high pressure treatment. This concentration was selected to avoid the formation of hard gels which are difficult to handle for ESI-MS analysis. Samples bags were submerged in the water chamber and the ultra-high pressure treatments applied were 550/0/1 and a three-cycle treatment at 400 MPa (i.e., 400/10/1 followed by 400/0/2). After pressure treatment, the samples were immediately frozen, subsequently lyophilized and re-dissolved to 0.5 mg/mL in 1% aqueous acetic acid (pH 3) for ESI-MS examination.

ESI Mass Spectrometry. ESI-MS analysis was carried out using a MICROMASS® Quattro II Triple Quadrupole mass spectrometer (Waters Corp., Manchester, UK) equipped with an electrospray source. Data acquisition and analyses were carried out using MASSLYNX™ version 3.5 software (Waters Corp., Manchester, UK). Nitrogen was used as curtain gas (400 L/hour, 100° C.) and nebulizing gas (20 L/hour). The ESI capillary was set at 1.94 kV while the MS analysis was carried out at a cone voltage of 80 V with an inter-scan delay of 0.1 second and a scan range of 800-2400 Da. The analytes were assayed in the positive mode with a flow rate of 300 mL/hour.

### EXAMPLE 5

Tertiary Structure Changes of Whey Proteins after Ultra High Pressure Treatment

Series A. Solutions of 15% (w/v) β-lactoglobulin were prepared in H₂O and sealed in plastic bags for high pressure treatment. This concentration was selected to avoid the formation of hard β-lactoglobulin gels, which after lyophilization can be difficult to re-dissolve and can cause artifacts in the fluorescence. The bags were submerged in the water chamber and subjected to ultra-high pressure treatments at 100/0/1, 250/0/1, 300/0/1, 400/0/1, 450/0/1, 500/0/1, 550/0/1, 600/0/1, 650/0/1, or a three-cycle treatment at 400 MPa (i.e., 400/10/1 followed by 400/0/2). After pressure treatment, the samples were immediately frozen, subsequently lyophilized and manipulated accordingly to the method of analysis.

Series B. BIPRO® and INPRO® whey protein isolates were subjected to 550/0/1 pressure treatment or a three-cycle pressure treatment (i.e., 400/10/1 followed by 400/0/2) and the fluorescence of the hydrophobic probe 8-anilino-1-naphthalene sulfonic acid (ANS) was recorded.

Fluorescence Spectroscopy using ANS as Probe. ANS, bound to β-lactoglobulin or whey protein isolate (5 mM protein solution containing 50 mM ANS in H₂O), was placed in a 10 mm path length quartz cuvette. An excitation wavelength of 486 nm and 2 nm slit was employed and the spectra were recorded from 400 to 600 nm using an Aminco-Bowman AB 2 spectrofluorimeter (Spectronics Instruments, Rochester, N.Y.).

Near UV Circular Dichroism Spectroscopy. A Jasco 710 spectropolarimeter (Jasco, Inc., Easton, Md.) was used to acquire the CD spectra of 3.33 mg/mL of β-lactoglobulin in H₂O placed in a 10-mm path length rectangular quartz cell. The spectral region from 320 to 250 nm was scanned at a rate of 20 nm/minute with a 2 second response, a 1-nm bandwidth, a 0.2 nm step resolution, a sensitivity setting of 30 and 5 accumulations.

FT-Raman Spectroscopy. The FT-Raman spectra were recorded using a Raman module coupled to a Nexus 670 FTIR spectrometer (Thermo Nicolet Corp., Madison, Wis.). Lyophilized protein powder was placed in a 1-mm glass capillary. A maximum laser power of 500 mW from a near-IR laser with a 1064 nm excitation was focused to a 100 pm diameter. A total 512 co-added scans at 8 cm⁻¹ spectral resolution were recorded for each sample. Spectra were normalized using the intensity of the 1005 cm⁻¹ band, which is insensitive to changes in structure (Li-Chan (1996) Trends Food Sci. Technol. 7:361-370).

### EXAMPLE 6

Augmentation of Intracellular Glutathione

Subjects. Thirty-six healthy subjects were recruited, with thirty one (15 females, 16 males) completing the study. This represented an 86% retention rate. Subjects gave informed consent and completed a medical assessment form and a Habitual Activity Assessment Scale (HAES) questionnaire (Boucher, et al. (1997) Am. J. Phys. Med. Rehabil. 76(4) :311-5) to determine habitual physical activity levels pre and post-supplementation.

Protocol. Subjects were randomized into three different groups. Subjects were asked to come into the lab on two different occasions at the same time of day two weeks apart. Subjects had a standard breakfast prior to testing on study days. On the first occasion, subjects filled in the required forms and then anthropometric characteristics were recorded. Ten mL of venous blood was then collected per subject from an antecubital vein to obtain baseline total lymphocyte GSH levels (oxidized+reduced GSH). After, subjects were given a two-week supply of pressurized whey protein in a chocolate mint bar format (Nellson Nutraceutical, Lachine, Quebec, Calif.) that was processed according to good manufacturing practices. Each bar contained 15 grams of pressurized whey protein isolate with a total of 21% fat, 47% carbohydrate, and 32% pressurized whey protein isolate per bar. Subjects were asked to consume either one, two, or three bars per day (190 kcal, 380 kcal, or 570 kcal total) depending on the group they were in. Subjects were asked to consume their typical diets and maintain an exercise level consistent with that before the trial.

Two weeks later, subjects returned to the lab on the same time of day where anthropometric variables were measured and the HAES questionnaire was completed. Also, another 10 mL of blood was withdrawn to assess total lymphocyte GSH levels post-supplementation.

Lymphocyte Preparation and GSH Analysis. Blood was diluted in an equal amount of RPMI-1640 medium, and the resultant mixture was placed in a tube containing 4 mL of FICOLL®-Hypaque, for the separation of lymphocytes (Boyum (1968) Scand. J. Clin. Lab. Invest. Suppl. 97:9-29). Two million lymphocytes were suspended in 970 uL of cold ice water. To this was added 30 uL of 30% 5-sulfosalicylic acid (SSA) to make a final concentration of 0.9% SSA and the solution was incubated on ice. The solution was centrifuged at 5000×g (8000 rpm, EPPENDORF® 5402) for 10 minutes at 4° C. The supernatant was removed and stored at −70° C. until analyzed for GSH content. Total GSH in the 0.9% SSA extract was determined by the well-established glutathione reductase recycling method (Tietze (1969) Anal. Biochem. 27(3) :502-22) adapted for the COBAS MIRA® spectrophotometer (Roche Diagnostics, Indianapolis, Ind.) (Grey, et al. (1998) Clin. Biochem. 31:301). Briefly, COBAS MIRA® pipettes, 210 μL NADPH (0.3 mmol/L), 30 μL DTNB (6.0 mmol/L), and 95 μL of sample, standard, or 0.9% SSA were placed into cuvettes. After a 4-minute incubation at 37° C., 15 μL glutathione reductase (1.0 U/100 μL) was added, and the reaction was monitored every 24 seconds for 12-minutes. Under these conditions, the method was linear for GSH concentrations between 0.5 to 5.0 μmol/L. The instrument constructed a calibration curve by assaying known GSH standards to generate a standard curve and the GSH concentrations of the unknown samples were determined. Using this method, the intra-assay coefficient of variations for GSH determinations at these concentrations was <2%. The control mean value (n=7) was 2.62 mmol per 2 million lymphocytes, with a range of 1.38 to 4.36 mmol per 2 million lymphocytes.

Statistical Analyses. Tests were performed using a commercially available software package (GB Stat, version 7.0; Dynamic Microsystems, Silver Spring, MD). Values were expressed as mean±SD. A one-way repeated measures ANOVA was used to determine if there was any difference in age, weight, height, body mass index (BMI), and total pre-lymphocyte GSH levels between the 3 groups (Group 1=15 grams/day; Group 2=30 grams/day; Group 3=45 grams/day). The independent variables of gender, age, height, weight, body mass index, and pre-supplementation lymphocyte GSH levels were examined by forward stepwise multiple regression to predict total post-supplementation lymphocyte GSH levels. A two-way repeated measures ANOVA analyzed the total number of hours of physical activity (somewhat active+active) per day as reported by the HAES questionnaire, comparing groups and time as the independent variables. Somewhat active was defined as walking, shopping, light household chores and active was defined as activities that required a great deal of movement and tended to make one breath hard such as running, biking, swimming, jumping.

### EXAMPLE 7

Enzymatic Digestion of Whey Proteins after Ultra High Pressure Treatment

The enzymatic digestion or whey proteins was according to established methods of digestion (Multilagi, et al. (1995) J. Food Sci. 60(5) :1104-1109; Kitabataki & Kinekawa (1998) J Agric. Food Chem. 46:4917-4923) with modification to simulate gastrointestinal digestion in vivo. To perform pepsin digestion after pressure treatment and freeze-drying, the pressurized whey proteins were diluted in double distilled water at a concentration of 3 mg/mL (0.3%) and the pH of the solution was adjusted to 1.5 with HCl. Triplicates of the solution were placed in a water bath at 37° C. and freshly prepared enzyme stock solution (5 mg/mL in HCl 0.01 M) was added to the 37° C. protein solutions to reach an enzyme to protein ratio equal to 1:100. The reaction was interrupted after 30 minutes by adding 1 M NaOH to the samples to elevate the pH to approximately 6, which is sufficient to irreversibly inactivate pepsin. The experiment was either stopped at this point or continued with pancreatin digestion. For pancreatin digestion, the samples were placed on ice and the pH was adjusted to 7.8 with 1 M NaOH and kept at −80° C. until the digestion with pancreatin was performed. For digestion with pancreatin, samples previously digested with pepsin were brought to room temperature and placed in a water bath at 40° C. in triplicates. Freshly prepared pancreatin stock solution (5 mg/mL in phosphate buffer pH 7) was added to each sample to reach an enzyme to protein ratio equal to 1:30. After 60 minutes, 150 mM Na₂CO₃ was added to the samples to stop the reaction.

Subsequent to enzyme digestion, hydrolysates were ultrafiltrated using regenerated cellulose membranes with a 1,000 kD cut-off in a stirred unit under gas nitrogen pressure of 40 psi at ˜4° C. Ultrafiltrated peptides were freeze-dried under standard conditions for subsequent posterior capillary zone electrophoresis analysis, HPLC analysis and cell culture experiments.

For pepsin digestion, the protein content of the whey protein solutions was determined at time 0 (before starting the digestion with pepsin), time 5, 10, 15, 20, 25 and 30 minutes (after starting the digestion with pepsin) using as standard Bradford assay. Protein content was also determined for quality control in terms of comparison of protein content before and after freeze-drying, after storage in −80° C., and before and after pH adjustments. Briefly, sample aliquots were mixed with dye reagent, incubated for 5 minutes at room temperature, and optical densities measured at 540 nm. Results were expressed as % of control (time 0), which corresponds to the total of whey protein in the solution before digestion. Considering that the protein content decreased as the digestion time progressed, the volume of the aliquot taken was determined at time 0 and was based on the maximum linear absorbance obtained from the standard curve using bovine serum albumin with the concentration ranging from 0.2 to 0.9 mg/mL.

To determine the amount of α-amino groups released during digestion, spectrophotometric assays employing o-phthaldialdehyde (OPA) were employed. Briefly, 50 mL of OPA solution was freshly prepared using 25 mL of 100 mM sodium tetraborate solution in water; 2.5 mL of 20% (wt/wt) SDS; 40 mg of OPA (dissolved in 1 mL of ethanol); 100 μL of β-mercaptoethanol, and water to complete the volume. Aliquots of each sample were collected before and after digestion with pepsin and pancreatin and incubated for 2 minutes with 1 mL of OPA solution. Considering that the α-aminogroup content increased as the digestion time progressed, the volume of the aliquot to be taken was determined at time 0 and was based on the minimum linear absorbance obtained from the standard curve using Phe-Gly with the concentration ranging from 25 to 150 μM. The optic densities (O.D.) were registered at 340 nm wavelength. Because absorbance was sensitive to the pH, the efficiency of the digestion was determined by measuring the O.D. at time 0 and 30 at pH 1.5 for pepsin digestion and at time 0 and at time 60 at pH 7.8 for pancreatin digestion. The O.D. was also determined after the ultrafiltration to detect the peptides with molecular weight less than 1,000 Da. The efficiency of the digestion was determined taking into consideration the net α-amino groups detected (O.D. before filtration less O.D. after filtration) after digestion with pepsin and after digestion with pancreatin. The results were expressed as μM of Phe-Gly.

### EXAMPLE 8

IL-8 Secretion

Cells were grown in pre-coated T-75 flasks in a medium containing (10% FBS) and re-fed every 2-3 days until confluent. Confluent, adherent monolayers were released from the plastic surface after treatment with polyvinyl-pyrrolidone (PVP)-trypsin-EDTA and seeded to 24-well plates or 50 mm dishes for 24 hours before receiving the treatments.

Cells were treated with native whey protein isolate and ultra high pressure treated whey at low doses chosen based on established effective peptides doses (Mercier, et al. (2004) Internat. Dairy J. 14:175-183). Wild-type and mutant ΔF508 CFTR cells were seeded at 0.4 and 0.6×10⁶ cells/mL in 24-well plates, respectively, and grown in Eagle's minimum essential medium (MEM) containing 10% FBS for 24 hour until nearly confluent. The MEM was replaced with fresh medium containing 2% FBS and filtered sterilized native whey protein and ultra high pressure-treated whey solutions at 12.5 μg/mL in water. The cells were allowed to grow for 24 hours at 37° C. in 5% CO₂ and after 24 hours the medium was replaced with fresh MEM 2% FBS containing the same initial concentration of whey protein hydrolysates in order to characterize the impact of native whey protein and ultra high pressure-treated whey on IL-8 release in an unstimulated basal condition. To assess the effect of whey protein hydrolysates on IL-8 production in a stimulated state, cells were treated with MEM 2% FBS containing 12.5 μg/mL of whey protein hydrolysates concurrently stimulated with human recombinant TNF-α (10 ng/mL) for an additional 24 hours. All experiments included unstimulated negative control wells.

After TNF-α treatment, the supernatant was collected to determine IL-8 release using commercially available ELISA kits. Briefly, 96-well plates were coated with capture antibody (anti-IL-8) overnight, washed with 0.05% TWEEN™-20 in PBS and coated with PBS containing 10% FBS in order to block non-specific binding. Known concentrations of IL-8 (standard) and cell supernatants containing released IL-8 were added as aliquots into appropriate wells, incubated for 2 hours and decanted from the wells. Anti-IL-8 antibody plus enzyme reagent (biotinylated detection antibody conjugated to streptavidin-horseradish) were added and incubated for 1 hour. After washing the plate, enzyme substrate (TMB-peroxide chromogen) was added to and the plate was incubated for 30 minutes. The reaction was stopped using a 2N H₂SO₄ solution and the absorbance was read at 450 nm using a Titertek II Multiscan MCCB40 (Labsystems, Finland). The optical densities were then used to calculate the IL-8 concentration from the standard curve and adjusted by their dilution factor.

What is claimed is:

1. A food protein composition comprising at least one protein subjected to a single cycle of ultra high pressure.

2. The food protein composition of claim 1, wherein the protein is a protein fraction of milk, soy or whey.

3. A nutraceutical, nutritional food, nutritional product or dietary supplement composition containing the food protein of claim 1 in admixture with a suitable carrier or excipient.

4. A nutraceutical, nutritional food, nutritional product or dietary supplement composition containing the food protein of claim 2 in admixture with a suitable carrier or excipient.

4. A method for increasing the digestibility of a food protein comprising subjecting a food protein to a single cycle of ultra high pressure so that the digestibility of the food protein is increased.

5. A method for increasing glutathione levels comprising administering an effective amount of a composition of claim 4 to a subject so that glutathione levels are increased in the subject.

6. A method for preventing or treating a disease or condition associated with glutathione deficiency comprising administering an effective amount of a composition of claim 4 to a subject with a disease or condition associated with glutathione deficiency thereby preventing or treating the disease or condition.

7. A method for providing a protein source comprising administering a composition of claim 3 to a subject with a protein deficiency thereby providing a protein source to the subject.


SEQUENCE LISTING (5 sequences)

SEQ ID NO: 1 - protein, 8 aa, Bos sp.
LSFNPTQL

SEQ ID NO: 2 - protein, 7 aa, Bos sp.
TPVVVPP

SEQ ID NO: 3 - protein, 7 aa, Bos sp.
VYPFPGP

SEQ ID NO: 4 - protein, 4 aa, Bos sp.
LEWV

SEQ ID NO: 5 - protein, 5 aa, Bos sp.
SLPEW